(19) United States
(12) Patent Application Publication
(10) Pub. No.: US 2010/0156971 A1
(43) Pub. Date: Jun. 24, 2010

(54) RECORDING APPARATUS

(75) Inventors: Hiroshi IKEDA, Kanagawa (JP); Kunichi YAMASHITA, Kanagawa (JP)

Correspondence Address: FILDES & OUTLAND, P.C., 20916 MACK AVENUE, SUITE 2, GROSSE POINTE WOODS, MI, 48236, US

(73) Assignee: FUJI XEROX CO., LTD., Tokyo (JP)

(21) Appl. No.: 12/464,995

(22) Filed: May 13, 2009

(30) Foreign Application Priority Data
Dec. 24, 2008 (JP) 2008-328130

(51) Int. Cl. B41J 29/38; B41J 2/01

(52) U.S. Cl. 347/9; 347/102

(57) ABSTRACT

The present invention provides a recording apparatus, which ejects a second liquid to a non-image area other than an image area formed by dots recorded by ejecting ink droplets onto a curable solution layer.

### CROSS-REFERENCE TO RELATED APPLICATION

This application is based on and claims priority under 35 USC 119 from Japanese Patent Application No. 2008-328130 filed Dec. 24, 2008.

### BACKGROUND

1. Field of the Invention

The present invention relates to a recording apparatus.

2. Related Art

There is an inkjet recording system as one system of recording images and data utilizing an ink. For recording systems using an ink, including the inkjet recording system, there has been proposed a system in which recording is carried out on an intermediate transfer member, and then transfer to a recording medium is carried out, in order to perform recording with various recording media such as a permeable medium and an impermeable medium with high image quality.

For example, a prior art discloses a recording method including adhering liquid on the surface of an intermediate transfer member prior to the transfer of flying ink droplets to the intermediate transfer member, adhering the ink onto the liquid, and then transferring the ink on the intermediate transfer member to a printing object together with the liquid.

Another prior art discloses a technique of forming an image layer by ejecting an ink containing a material capable of curing through ultraviolet ray irradiation onto an intermediate member, irradiating ultraviolet rays to the image layer to partially cure the layer, and then contacting a recording medium with the intermediate member to transfer the image layer.

### SUMMARY

According to an aspect of the invention, there is provided a recording apparatus including: an intermediate transfer member; a supplying unit that supplies a curable solution containing at least a curable resin that cures by a stimulus from the outside, onto the intermediate transfer member; a first ejection unit that ejects an ink to a curable solution layer formed on the intermediate transfer member; a second ejection unit that ejects a second liquid to the curable solution layer; a transferring unit that contacts the curable solution layer to which the ink and the second liquid have been ejected with a recording medium to transfer the curable solution layer from the intermediate transfer member to the recording medium; a stimulus supplying unit that supplies a stimulus for curing the curable solution layer, to the curable solution layer; and a control unit that controls the first ejection unit to eject, on the basis of image data, the ink to record dots in accordance with respective pixels of an image of the image data, and controls the second ejection unit so as to eject the second liquid to a non-image area other than the image area formed by the ejection of the ink, on the curable solution layer.

### BRIEF DESCRIPTION OF THE DRAWINGS

Exemplary embodiments of the present invention will be described in detail based on the following figures, wherein:

FIG. 1 is a schematic configuration view illustrating a recording apparatus according to a first embodiment.

FIG. 2 is a schematic block diagram showing the main controller of the recording apparatus according to the first embodiment.

FIG. 3 is a flow chart showing the generation of data of a second liquid executed in a second liquid data generating portion of the recording apparatus according to the first embodiment.

FIG. 4 is a schematic view showing an image area formed by the ejection of ink droplets and a non-image area other than the image area on a curable solution layer formed on an intermediate transfer belt.

FIG. 5 is a schematic view showing the process of transferring the image area and the non-image area on the curable solution layer formed on the intermediate transfer belt to a recording medium P.

FIG. 6 is a schematic configuration view illustrating a recording apparatus according to a second embodiment.

FIG. 7 is a schematic block diagram showing the main controller of the recording apparatus according to the second embodiment.

FIG. 8 is a flow chart showing the generation of data of a second liquid executed in a second liquid data generating portion of the recording apparatus according to the second embodiment.

FIG. 9 is a view showing a frame format of an image area formed by the ejection of ink droplets and a non-image area other than the image area on a curable solution layer formed on an intermediate transfer belt.

FIG. 10 is a schematic configuration view illustrating a recording apparatus according to a third embodiment.

FIG. 11 is a schematic block diagram showing the main controller of the recording apparatus according to the third embodiment.

FIG. 12 is a flow chart showing the generation of data of a second liquid executed in a second liquid data generating portion of the recording apparatus according to the third embodiment.

FIG. 13 is a schematic view showing an image area formed by the ejection of ink droplets and a non-image area other than the image area on a curable solution layer formed on an intermediate transfer belt.

FIG. 14 is a schematic view showing an image area formed by the ejection of ink droplets and a non-image area other than the image area on a curable solution layer formed on an intermediate transfer belt.

FIG. 15 is a schematic view showing an image area formed by the ejection of ink droplets and a non-image area other than the image area on a curable solution layer formed on an intermediate transfer belt.

### DETAILED DESCRIPTION

Exemplary embodiments of the invention are described in detail hereinafter.

A first exemplary embodiment of the invention is a recording apparatus comprising: an intermediate transfer member; a supplying unit that supplies a curable solution containing a curable resin that cures by a stimulus from the outside, onto the intermediate transfer member; a first ejection unit that ejects an ink to a curable solution layer formed on the intermediate transfer member; a second ejection unit that ejects a second liquid to the curable solution layer; a transferring unit that contacts the curable solution layer to which the ink and the second liquid have been ejected with a recording medium to transfer the curable solution layer from the intermediate transfer member to the recording medium; a stimulus supplying unit that supplies a stimulus for curing the curable solution layer, to the curable solution layer; and a control unit that controls an ejection of the ink with the first ejection unit to eject, on the basis of image data, the ink to record dots in accordance with respective pixels of an image of the image data, and controls an ejection of the second liquid with the second ejection unit to eject the second liquid on the curable solution layer.

A second exemplary embodiment of the invention is the recording apparatus according to the first exemplary embodiment of the invention, further comprising a release agent supplying unit that supplies a release agent onto the intermediate transfer member.

A third exemplary embodiment of the invention is the recording apparatus according to the first exemplary embodiment or the second exemplary embodiment of the invention, wherein the stimulus is an ultraviolet ray, an electron beam or heat.

A fourth exemplary embodiment of the invention is the recording apparatus according to any one of from the first exemplary embodiment to the third exemplary embodiment of the invention, wherein the intermediate transfer member has a property of stimulus permeability that allows the stimulus to permeate.

A fifth exemplary embodiment of the invention is the recording apparatus according to any one of from the first exemplary embodiment to the fourth exemplary embodiment of the invention, further comprising a cleaning device for cleaning a residual material or an adhered material on the surface of the intermediate transfer member after transferring the curable solution layer from the intermediate transfer member to the recording medium.

A sixth exemplary embodiment of the invention is the recording apparatus according to any one of from the first exemplary embodiment to the fifth exemplary embodiment of the invention, further comprising a stimulus supply device for further curing the curable solution layer that has been transferred to the recording medium.

A seventh exemplary embodiment of the invention is the recording apparatus according to any one of from the first exemplary embodiment to the sixth exemplary embodiment of the invention, wherein the control unit includes a calculation unit that calculates a maximum ejection amount of the ink for recording the dots in accordance with respective pixels of the image of the image data on the basis of the image data, and controls the second ejection unit so as to eject the second liquid to areas corresponding to respective pixels of the non-image area in an amount being equal to or less than the maximum ejection amount.

An eighth exemplary embodiment of the invention is the recording apparatus according to any one of from the first exemplary embodiment to the seventh exemplary embodiment of the invention, wherein the second liquid is a pale colored solution.

A ninth exemplary embodiment of the invention is the recording apparatus according to the eighth exemplary embodiment of the invention, wherein the control unit includes a calculation unit that calculates the maximum ejection amount of the ink for recording the dots in accordance with respective pixels of the image of the image data on the basis of the image data, determines the ejection amount of the second liquid to be ejected to areas corresponding to respective pixels of the image area for each pixel so that the summed amount of the ejection amount of the ink ejected for recording a dot in accordance with respective pixels of the image area and the ejection amount of the second liquid ejected to the area where the dot is recorded becomes equal to the maximum ejection amount, controls the second ejection unit so as to eject the second liquid in the determined ejection amount to areas corresponding to respective pixels, and controls the second ejection unit so as to eject the second liquid to areas corresponding to respective pixels of the non-image area in an amount being equal to or less than the maximum ejection amount.

A tenth exemplary embodiment of the invention is the recording apparatus according to any one of from the first exemplary embodiment to the eighth exemplary embodiment of the invention, wherein the control unit controls the second ejection unit so as to define an area along the outer border of the image area formed on the curable solution layer as the non-image area and to eject the second liquid to the non-image area.

An eleventh exemplary embodiment of the invention is the recording apparatus according to the tenth exemplary embodiment of the invention, wherein the control unit controls the second ejection unit so that the ejection amount of the second liquid decreases as the distance from the boundary between the image area and the non-image area increases for the area along the outer border of the image area defined as the non-image area.

A twelfth exemplary embodiment of the invention is the recording apparatus according to the eleventh exemplary embodiment of the invention, wherein the control unit includes a calculation unit that calculates a maximum ejection amount of the ink for recording a dot in accordance with respective pixels of the image of the image data on the basis of the image data, and controls the second ejection unit so as to eject the second liquid to an area corresponding to a pixel continuous to the boundary between the image area and the non-image area among pixels in the area along the outer border of the image area defined as the non-image area in an ejection amount being equal to or less than the maximum ejection amount, and to decrease the ejection amount of the second liquid as the distance from the boundary increases.

A thirteenth exemplary embodiment of the invention is a method forming an image with the recording apparatus according to any one of from the first exemplary embodiment to the twelfth exemplary embodiment of the invention.

Exemplary embodiments of the present invention are to be described with reference to the drawings. Throughout the drawings, those members having substantially identical functions carry same reference characters, and duplicated descriptions thereon are sometimes omitted.

### First Embodiment

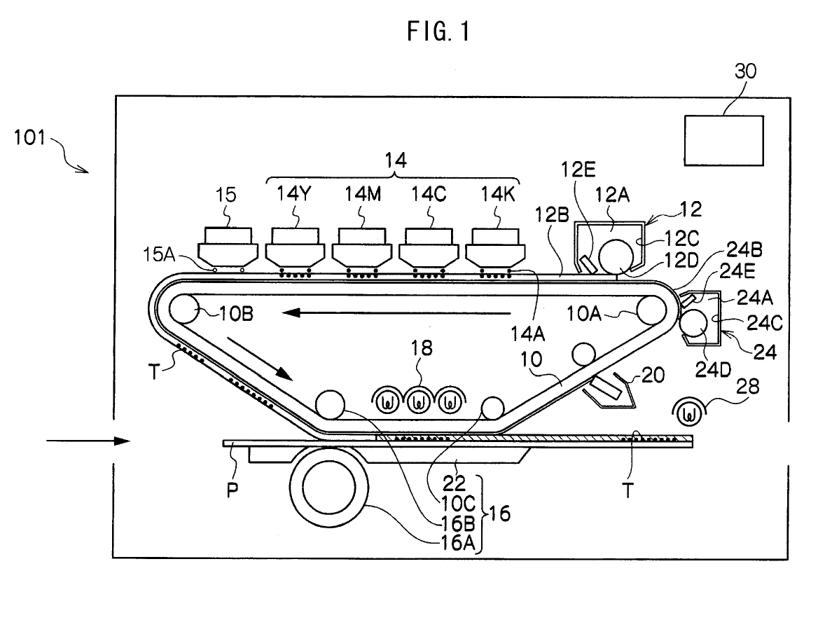

FIG. 1 is a schematic configuration view illustrating a recording apparatus according to a first embodiment.

As shown in FIG. 1, a recording apparatus 101 according to the first embodiment is provided, for example, around an endless belt-shaped intermediate transfer belt 10 from the upstream side in the moving direction (arrow direction) of the intermediate transfer belt 10 in order, with a release agent applying device 24 that forms a release agent layer 24B (detailed later) on the intermediate transfer belt 10, a solution supply device 12 that supplies a curable solution 12A (detailed later) on the release agent layer 24B to form a curable solution layer 12B, an inkjet recording head 14 that ejects ink droplets 14A to the curable solution layer 12B formed on the intermediate transfer belt 10 in accordance with respective pixels of an image being the formation object and forming a dot to form an image on the curable solution layer 12B, a second liquid ejection head 15 that ejects a second liquid (detailed later) 15A on the curable solution layer 12B, a transfer device 16 that transfers the curable solution layer 12B, to which the ink droplets 14A and the second liquid 15A have been ejected, onto a recording medium P by contacting and pressing the curable solution layer 12B to the recording medium P, and a cleaning device 20 that removes a residual material of the curable solution layer 12B remaining on the surface of the intermediate transfer belt 10 or an adhered material (such as paper powder of the recording medium P).

Further, inside the intermediate transfer belt 10, there is arranged a stimulus supply device 18 (stimulus supplying unit) that supplies a stimulus for curing the curable solution layer 12B during the contact of the curable solution layer 12B with the recording medium P. Namely, the stimulus supply device 18 is set up so as to face to the region where the curable solution layer 12B contacts with the recording medium P.

Furthermore, in the recording apparatus 101, a main controller 30 is provided for controlling respective device portions provided in the recording apparatus 101, which is connected to be capable of giving/receiving signals to/from respective device portions, a drawing being omitted.

In addition, the recording apparatus 101 corresponds to the recording apparatus of the invention, and the intermediate transfer belt 10 corresponds to the intermediate transfer member of the recording apparatus of the invention. Further, the solution supply device 12 corresponds to the supplying unit of the recording apparatus of the invention, and the inkjet recording head 14 corresponds to a first ejection unit of the recording apparatus of the invention. Furthermore, the second liquid ejection head 15 corresponds to a second ejection unit of the recording apparatus of the invention. The transfer device 16 corresponds to the transferring unit of the recording apparatus of the invention, and the stimulus supply device 18 corresponds to the stimulus supplying unit of the recording apparatus of the invention. In addition, the main controller 30 corresponds to a control unit of the recording apparatus of the invention, and a calculation portion 39A, described later, provided in the main controller 30 corresponds to a calculation unit of the recording apparatus of the invention.

The intermediate transfer belt 10 is, for example, supported and set up with three support rolls 10A to 10C, and a pressure roll 16B so as to rotate while being applied with tension from the inner circumferential face side. The intermediate transfer belt 10 has a width (length in the shaft direction) that is equal to or wider than the width of the recording medium P.

Examples of the material for the intermediate transfer belt 10 include, materials generally known for the intermediate transfer belt, for example, one or more selected from various resins (for example, polyimide, polyamidoimide, polyester, polyurethane, polyamide, polyether sulfone, fluorine-containing resin, etc.); various rubbers (for example, nitrile rubber, ethylene propylene rubber, chloroprene rubber, isoprene rubber, styrene rubber, butadiene rubber, butyl rubber, chlorosulfonated polyethylene, urethane rubber, epichlorohydrin rubber, acryl rubber, silicone rubber, and fluorine rubber, etc.); and a metal material such as stainless steel.

The intermediate transfer belt 10 may have a monolayer structure or a multilayer structure.

As described above, in the embodiment, the stimulus supply device 18 is provided inside the intermediate transfer belt 10, and, therefore, the stimulus is supplied to the curable solution layer 12B after penetrating the intermediate transfer belt 10. Accordingly, the intermediate transfer belt 10 is preferably one having high stimulus permeability in order to effectively supply the stimulus to the curable solution layer 12B. Also, the intermediate transfer belt 10 is preferably one having high stimulus resistance.

For example, when the stimulus supply device 18 is an ultraviolet ray irradiation device, the intermediate transfer belt 10 is preferably one having high ultraviolet ray permeability and high durability against ultraviolet rays. Specifically, for example, the intermediate transfer belt 10 has ultraviolet ray permeability of 70% or more. The ultraviolet ray permeability of the intermediate transfer belt 10 within the above range allows ultraviolet ray energy necessary for the curing reaction of the curable solution layer 12B to be effectively supplied to the curable solution layer 12B and, at the same time, suppresses the generation of heat caused by the absorption of ultraviolet rays by the intermediate transfer belt 10, and the like.

Specific examples of materials for forming such intermediate transfer belt 10 include ETFE (ethylene-tetrafluoloethylene copolymer), polyethylene terephthalate film, polyolefin-based films and the like.

In the embodiment, the intermediate transfer belt 10 preferably has a low surface free energy (γ_{T}) at the surface contacting to the curable solution layer 12B. Particularly, the surface free energy (γ_{T}) is preferably lower than the surface free energy (γₚ) of the recording medium P at the surface contacting to the curable solution layer 12B, and, a condition satisfying the following Formula is more preferable.

Formula: γₚ−γ_{T}>10

The value of the surface free energy can be obtained, for example, by a method below.

Specifically, a value of surface free energy is calculated with a contact angle meter CAM-200 (manufactured by KSV), by program calculation using a Zisman method built in the apparatus.

The release agent applying device 24 is arranged on the further upstream side than the solution supply device 12 in the moving direction of the intermediate transfer belt 10. Namely, the release agent applying device 24 is arranged between the solution supply device 12 and the cleaning device 20 around the intermediate transfer belt 10.

The release agent applying device 24 is constituted, for example, by including a supply roller 24D for supplying the release agent 24A to the intermediate transfer belt 10, and a blade 24E for defining the thickness of a release agent layer 24B formed by the release agent 24A having been supplied, and, according to need, it may include a heating unit (not shown) for heating and melting the release agent 24A, in a housing 24C for storing the release agent 24A.

The release agent applying device 24 may be constituted so as to allow the supply roller 24D to continuously contact with the intermediate transfer belt 10, or so as to be separated from the intermediate transfer belt 10. The release agent applying device 24 is not limited to have the above constitution. Devices utilizing publicly known coating methods (such as bar coater coating, coating of a spray system, coating of an inkjet system, coating of an air knife system, coating of a blade system and coating of a roller system) may be applied.

Specific examples of the release agent 24A include silicone-based oils, fluorine-containing oils, hydrocarbon-based polyalkylene glycol, fatty acid ester, phenyl ether, phosphoric acid ester and the like. Among them, silicone-based oils, fluorine-containing oils and polyalkylene glycol are preferable.

Examples of the silicone-based oils include straight silicone oil and modified silicone oil.

Examples of the straight silicone oil include dimethylsilicone oil and methylhydrogensilicone oil.

Examples of the modified silicone oil include methylstyryl-modified oil, alkyl-modified oil, higher fatty acid ester-modified oil, fluorine-modified oil, and amino-modified oil.

Examples of the polyalkylene glycol include polyethylene glycol, polypropylene glycol, ethylene oxide-propylene oxide copolymer and polybutylene glycol. Among them, polypropylene glycol and polyethylene glycol are preferable.

In the embodiment, a case where the release agent 24A is coated on the intermediate transfer belt 10 is described. But, when a material having good surface releasability such as ETFE (ethylene-tetrafluoloethylene copolymer) is used for the intermediate transfer belt 10, the coating of the release agent 24A is unnecessary.

In the recording apparatus 101 according to the embodiment, the release agent 24A is previously coated on the surface of the intermediate transfer belt 10 by the release agent applying device 24, before supply the curable solution 12A to the surface of the intermediate transfer belt 10 by the solution supply device 12, to form the release agent layer 24B. Next, by the solution supply device 12, the curable solution 12A is fed to the release agent layer 24B on the intermediate transfer belt 10.

The solution supply device 12 is constituted, for example, by including a supply roller 12D for supplying the curable solution 12A to the intermediate transfer belt 10 and a blade 12E for defining the thickness of the curable solution layer 12B formed by the curable solution 12A having been supplied, in a housing 12C storing the curable solution 12A.

The solution supply device 12 may be constituted so as to allow the supply roller 12D thereof to continuously contact with the intermediate transfer belt 10, or so as to be separated from the intermediate transfer belt 10. In the solution supply device 12, an independent solution supply system (not shown) may be used to supply the curable solution 12A to the housing 12C, to prevent a break in the supply of the curable solution 12A. Details of the curable solution 12A is described later.

The solution supply device 12 is not limited to have the above constitution. Devices utilizing publicly known supply methods (coating methods such as die coater coating, bar coater coating, coating of a spray system, coating of an inkjet system, coating of an air knife system, coating of a blade system and coating of a roller system) may be applied.

The inkjet recording head 14 ejects ink droplets towards the outer circumferential face side of the intermediate transfer belt 10. The inkjet recording head 14 is constituted of at least inkjet recording heads for respective colors of an inkjet recording head 14K for ejecting black ink droplets, an inkjet recording head 14C for ejecting cyan ink droplets, an inkjet recording head 14M for ejecting magenta ink droplets and an inkjet recording head 14Y for ejecting yellow ink droplets, for example, from the upstream side in the moving direction of the intermediate transfer belt 10. Of course, the constitution of the inkjet recording head 14 is not limited to the above-described constitution. For example, the inkjet recording head 14 may be constituted of the inkjet recording head 14K alone, or of only the inkjet recording head 14C, inkjet recording head 14M and the inkjet recording head 14Y.

Respective inkjet recording heads 14 are arranged above the non-bending region in the intermediate transfer belt 10 rotatably supported by the addition of tension while adjusting the distance between the surface of the intermediate transfer belt 10 and the nozzle face of the inkjet recording head 14 to, for example, 0.7 mm to 1.5 mm.

Respective inkjet recording heads 14 preferably are, for example, a line type inkjet recording head having a width equal to or greater than the width of the recording medium P, but a conventional scanning type inkjet recording head may also be employed.

No limitation is imposed on the constitution of the ink ejection system for respective inkjet recording heads 14 as long as the ink droplets can be ejected, including systems such as a piezoelectric element driving type and a heating element driving type capable of ejecting the ink drop. The details of the ink will be described later.

The second liquid ejection head 15 ejects the second liquid towards the outer circumferential face side of the intermediate transfer belt 10.

The second liquid is a liquid that has a hue that does not influence the hue (for example, white or transparent) of an image area T formed by the ink droplets 14A, and that adjusts the surface irregularity state of the curable solution layer 12B by being ejected to the curable solution layer 12B. Details of the composition of the second liquid will be described later. The term “transparent” means that the transmittance for light having a wavelength in the visible region is 50% or more.

The second liquid ejection head 15 is arranged above the non-bending region in the intermediate transfer belt 10 rotatably supported by the addition of tension while adjusting the distance between the surface of the intermediate transfer belt 10 and the nozzle face of the second liquid ejection head 15 to, for example, 0.7 mm to 1.5 mm, in a similar manner to that in the inkjet recording head 14.

Further, as the second liquid ejection head 15, the use of one, for which, for example, a liquid to be ejected is changed from the ink to the second liquid in a line type inkjet recording head having a width equal to or greater than the width of the recording medium P, is preferable. But, a head, for which a liquid to be ejected is changed from the ink to the second liquid in a conventional scanning type inkjet recording head, may also be used.

No limitation is imposed on the constitution of the ejection system for ejecting the second liquid with the second liquid ejection head 15 as long as the second liquid can be ejected, including systems such as a piezoelectric element driving type and a heating element driving type capable of ejecting the second liquid.

The transfer device 16 is constituted as follows. Specifically, for example, the intermediate transfer belt 10 is stretched by a pressure roll 16B and a support roll 10C to form a non-bending region. In the non-bending region of the intermediate transfer belt 10, at a place facing to the pressure roll 16B and the support roll 10C, a support 22 for supporting the recording medium P is provided. The pressure roll 16A is arranged at a place facing to the pressure roll 16B of the intermediate transfer belt 10 and contacts with the recording medium P through an opening (not shown) provided at the support 22.

Namely, in a transfer region from a position where the intermediate transfer belt 10 and the recording medium P are nipped by the pressure rolls 16A and 16B (hereinafter, occasionally referred to as a “contact-starting position”) to a position where they are nipped by the support roll 10C and the support 22 (hereinafter, occasionally referred to as a “peeling position”), the curable solution layer 12B is in a state of contacting with both the intermediate transfer belt 10 and the recording medium P.

The stimulus supply device 18 is arranged inside the intermediate transfer belt 10, and supplies a stimulus to the curable solution layer 12B in a state of contacting with both the intermediate transfer belt 10 and the recording medium P, via the intermediate transfer belt 10 in the transfer region.

The stimulus supply device 18 is selected in accordance with the curable resin contained in the curable solution 12A to be applied. Specifically, for example, when applying an ultraviolet curable resin that is cured by the irradiation of ultraviolet rays, an ultraviolet ray irradiation device for irradiating ultraviolet rays to the curable solution 12A (the curable solution layer 12B formed from the curable solution 12A) is applied as the stimulus supply device 18. When applying an electron beam curable resin cured by the irradiation of electron beams, an electron beam irradiation device for irradiating electron beams to the curable solution 12A (the curable solution layer 12B formed from the curable solution 12A) is applied as the stimulus supply device 18. When applying a heat curable resin cured by heating, a heating device for heating the curable solution 12A (the curable solution layer 12B formed from the curable solution 12A) is applied as the stimulus supply device 18.

UV irradiation devices applicable herein include, for example, a metal halide lamp, a high pressure mercury lamp, an ultra high pressure mercury lamp, a deep UV-ray lamp, a lamp in which a mercury lamp is excited, without electrodes, from the outside by using microwaves, a UV laser, a xenon lamp, a UV-LED, etc.

The irradiation condition of the ultraviolet rays is not specifically limited and may be selected depending on the type of the ultraviolet curable material, the thickness of the curable solution layer 12B, etc. Examples of the condition include, for instance, the condition that an integrated amount of light is within a range of from 20 mJ/cm² to 1000 mJ/cm² in the case where a metal halide lamp is used.

Examples of the electron beam irradiation device include a scanning type and a curtain type, and the curtain type is a device that draws out thermoelectrons generated on a filament by a grid in a vacuum chamber, rapidly accelerates them with a high voltage (for example, from 70 kV to 300 kV) to make an electron stream, and emits it to the atmosphere side through a window foil. The wavelength of the electron beams is generally smaller than 1 nm, and the energy of the electron beams may reach several MeV. However, electron beams with a wavelength number in the order of pm and an energy of from several ten keV to several hundred keV may be used.

The irradiation condition of the electron beams is not specifically limited and may be selected depending on the type of the electron beam curable material, the thickness of the curable solution layer 12B, etc. Examples of the condition include the condition that the amount of the electron beams is in a range of from 5 kGy to 100 kGy level.

Examples of the heat applying device include a halogen lamp, a ceramic heater, a nichrome-wire heater, a microwave heater, and an infrared ray lamp. A heating device with an electromagnetic induction method may be applied as the heat applying device.

The heat applying condition is not specifically limited and may be selected depending on the type of the thermosetting material, the thickness of the curable solution layer 12B, etc. Example of the condition includes the condition that the heating is performed in air at 200° C. for 5 minutes.

As the recording medium P, either of permeable media (such as regular paper and coated paper) and impermeable media (such as art paper and a resin film) are applied. The recording medium P is not limited to these, but includes industrial products such as a steel plate and a semiconductor substrate.

In the recording apparatus 101 having the above whole constitution, the intermediate transfer belt 10 is rotationally driven. Firstly, a release agent layer 24B is formed on the surface of the intermediate transfer belt 10 by the release agent applying device 24, and, the curable solution 12A is supplied on the release agent layer 24B by the solution supply device 12 to form the curable solution layer 12B.

Here, no particular limitation is imposed on the layer thickness (average film thickness) of the curable solution layer 12B, but, from the standpoint of satisfying both image formation properties and transferring properties, the thickness of the curable solution layer 12B is preferably from 1 μm to 50 μm, and, more preferably from 3 μm to 20 μm.

Further, when the thickness of the curable solution layer 12B is set so that the ink droplets 14A do not reach the lowermost layer of the curable solution layer 12B, a region in the curable solution layer 12B where the ink droplets 14A are present is not exposed after the transfer to the recording medium P, and a region where the ink droplets 14A are not present functions as a protective layer after curing.

Next, the inkjet recording head 14 ejects the ink droplets 14A for recording dots in accordance with respective pixels of an image to be formed from image data of a formation object on the curable solution layer 12B by the control of a main controller 30 described later. By this, an image area is formed to the curable solution layer 12B by dots recorded by the ejected ink droplets. In the embodiment, description will be performed by referring the region where the dots, which are recorded by the ejection of the ink droplets 14A onto the curable solution layer 12B, are formed as an “image area.” Here, the curable solution layer 12B preferably has a property of fixing an ink color material when the ink is supplied.

And, further, on the curable solution layer 12B, the second liquid is ejected by the second liquid ejection head 15, and the second liquid is ejected to at least the non-image area of the curable solution layer 12B (detailed later). In the embodiment, the “non-image area” is the area other than the image area on the curable solution layer 12B. In more detail, the non-image area shows the area other than the image area, in an area on the curable solution layer 12B corresponding to the recording medium P being the object of recording an image in the recording apparatus 101.

The ejection of the ink droplets 14A by the inkjet recording head 14 and the ejection of the second liquid 15A by the second liquid ejection head 15 are performed above the non-bending region in the intermediate transfer belt 10 that is rotatably supported in a stretched state. Namely, in a state in which the belt surface has no bending, the ink droplets 14A and the second liquid 15A are ejected to the curable solution layer 12B.

In the embodiment, a case, where the ejection of the second liquid 15A is performed by the second liquid ejection head 15 after the ejection of the ink droplets 14A by the inkjet recording head 14 onto the curable solution layer 12B, is described. But, a constitution, in which the ejection of the ink droplets 14A to the curable solution layer 12B is performed by the inkjet recording head 14 after the ejection of the second liquid 15A to the curable solution layer 12B by the second liquid ejection head 15, may be adopted. In this case, it is sufficient to have a constitution in which the second liquid ejection head 15 is arranged on the upstream side of the inkjet recording head 14 in the moving direction of the intermediate transfer belt 10, and on the downstream side of the solution supply device 12 in the moving direction.

However, the constitution, in which the second liquid 15A is ejected after the ejection of the ink droplets 14A, is preferable from the reason that it hardly influences the bleeding of a ink at the surface of the curable solution layer.

Next, the recording medium P and the intermediate transfer belt 10 are nipped by the pressure rolls 16A and 16B of the transfer device 16 to apply pressure. In this process, the curable solution layer 12B on the intermediate transfer belt 10 contacts with the recording medium P (contact-starting position). After that, to the position nipped by the support roll 10C and the support 22 (peeling position), the state, in which the curable solution layer 12B contacts with both the intermediate transfer belt 10 and the recording medium P, is maintained.

Next, the curable solution layer 12B cures by supplying a stimulus to the curable solution layer 12B that is in a state of contacting with both the intermediate transfer belt 10 and the recording medium P (during contact) by the stimulus supply device 18 via the intermediate transfer belt 10. Specifically, after the contact of the curable solution layer 12B on the intermediate transfer belt 10 with the recording medium P (after passing the contact-starting position), the supply of the stimulus is started, and, before the peeling of the curable solution layer 12B from the intermediate transfer belt 10 (before reaching the peeling position), the supply of the stimulus is terminated.

The supply amount of stimulus is preferably an amount for completely curing the curable solution layer 12B. Specifically, for example, when the stimulus is ultraviolet ray, accumulated amount of light is preferably in a range of from 10 mJ/cm² to 1000 mJ/cm² from the standpoints of transferring efficiency and suppressing heat generation.

When the stimulus is supplied in such an amount that allows the curable solution layer 12B to cure to a degree capable of being peeled from the intermediate transfer belt 10, it is sufficient to supply stimulus in such an amount that can completely cure the curable solution layer 12B after the transferring/peeling.

In the embodiment, a case, in which a stimulus is supplied to the curable solution layer 12B in a state of contacting with both the intermediate transfer belt 10 and the recording medium P by the stimulus supply device 18 via the intermediate transfer belt 10 to cure the curable solution layer 12B, is described. But, another constitution, in which a stimulus supply device 28 for complete curing after the transferring for the purpose of completely curing the curable solution layer 12B after being transferred to the recording medium P is further provided, may be used to further cure the curable solution layer 12B transferred to the recording medium P.

Next, the peeling of the curable solution layer 12B from the intermediate transfer belt 10 at the peeling position forms a cured resin layer (image layer), on which an image area T is formed by the ink droplets 14A, on the recording medium P.

Residual materials of the curable solution layer 12B remained on the surface of the intermediate transfer belt 10 after transferring the curable solution layer 12B to the recording medium P and adhered materials are removed by the cleaning device 20, the curable solution layer 12B is again formed by supplying the curable solution 12A on the intermediate transfer belt 10 by the solution supply device 12, and the image recording process is repeated.

In the recording apparatus 101 in the embodiment, the image recording is performed as described above.

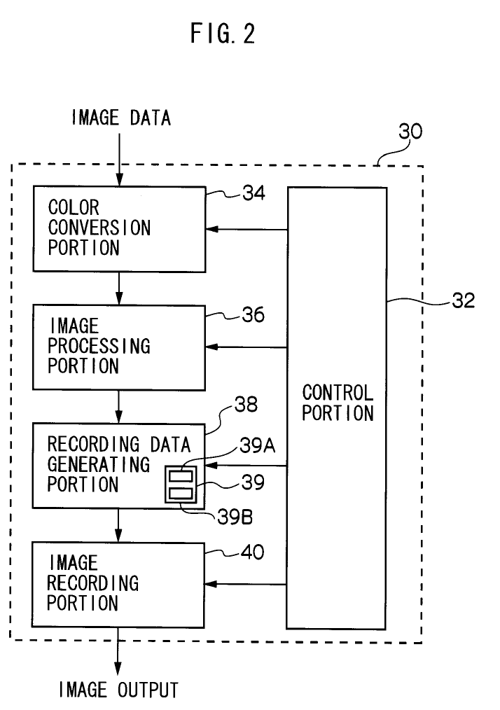

FIG. 2 is a schematic block diagram of the main controller 30. As shown in FIG. 2, the main controller 30 is constituted of at least a control portion 32, a color converting portion 34, an image processing portion 36, a recording data generating portion 38, and an image recording portion 40.

It is intended that the main controller 30 obtains image data of an object to be recorded with the recording apparatus 101 from an external apparatus via a wireless line or a wire line via an input/output device, which is not shown, provided in the recording apparatus 101. The image data are inputted to the color converting portion 34 described later.

Further, it is intended that the image data inputted to the color converting portion 34 include data of respective pixels of the whole area of the recording medium P being the image formation object. Namely, it is intended that the image data includes data of pixels corresponding to both the image area and the non-image area.

It is intended that the data of respective pixels include information showing the position of respective pixels on the recording medium P (such as the position in row direction and the position in column direction) and the color of respective pixels (such as RGB data).

The control portion 32 generally controls the color converting portion 34, the image processing portion 36, the recording data generating portion 38, and the image recording portion 40. The image recording portion 40 includes a component for recording an image in the recording apparatus 101 described with reference to FIG. 1.

Here, in the embodiment, the inkjet recording head 14 is provided with inkjet recording heads 14Y, 14M, 14C and 14K for ejecting ink droplets of four colors of Y, M, C and K, respectively.

Consequently, for example, the color converting portion 34 performs color correction and density correction, for example, in accordance with the properties of the recording medium P and the ink, as well as performing, when the inputted image data of an image being the formation object are RGB data, processing of converting the RGB data to CMYK data is performed for each pixel in accordance with the color of ink droplets ejected from the inkjet recording head 14 provided in the recording apparatus 101.

The color correction processing is generally performed using a correction table referred to as LUT (Look Up Table).

The image processing portion 36 performs a so-called half gradation processing for each pixel. Namely, data having a comparatively high gradation such as 256-gradation are converted to image data having a gradation number that can be recorded with the image recording portion 40. The processing is performed for each of YMCK colors of respective pixels.

The gradation number that can be recorded with the inkjet recording head 14 of the recording apparatus 101 is generally from 2 to 8. But, in the embodiment, for simplifying the description, a case, in which each of YMCK colors has two gradations, namely, the gradation number of the ink droplets 14A ejected from respective nozzles of inkjet recording heads 14 for respective colors (inkjet recording heads 14Y, 14M, 14C and 14K) is two (namely, no ejection or ejection in a normal amount), will be described as one example.

Further, in the embodiment, for the second liquid, a case, in which the gradation number is five in accordance with the kind of an ink ejected from the inkjet recording head 14, is described. Details will be described later. For the purpose, there are described five cases including the case where no second liquid is ejected from the second liquid ejection head 15; the case where the second liquid is ejected at the same amount (namely, normal amount) as the ink amount ejected at one time from one nozzle of the inkjet recording head 14 for one color among the inkjet recording heads 14 for respective colors; the case where the liquid is ejected at two times as large as the normal amount (amount for two colors); the case where the liquid is ejected at three times as large as the normal amount (amount for three colors); and the case where the liquid is ejected at four times as large as the normal amount (amount for four colors).

In the embodiment, a case, in which the gradation number of the ink droplets 14A ejected from respective nozzles of inkjet recording heads 14 for respective colors is two as described above and the gradation number of the second liquid 15A ejected from the second liquid ejection head 15 is five as described above, is described. But, needless to say, the combination is not limited to these gradations.

The recording data generating portion 38 converts the image data having been binarized for respective YMCK colors of respective pixels in the image processing portion 36 to a data construction that is decodable by the image recording portion 40, and rearranges data in a recording order (transmitting order) to output the resulting data to the image recording portion 40. In this process, the recording data generating portion 38 generates the recording data considering ejection timing and data arrangement associated with the arrangement of inkjet recording heads and nozzles.

Further, the recording data generating portion 38 according to the embodiment generates not only data for the ejection of inks of YMCK four colors, but data of the second liquid for the ejection of the second liquid to the non-image area other than the image area formed by dots recorded by ejecting the ink droplets 14A on the curable solution layer 12B, on the basis of respective pixel values of image data of a formation object. The data of the second liquid are generated by a second liquid data generating portion 39 provided in the recording data generating portion 38 (details are described later).

The image recording portion 40 allows nozzles of inkjet recording heads 14 for respective colors to eject the ink droplets 14A according to the recording data of YMCK generated in the recording data generating portion 38, as well as it allows the nozzle of the second liquid ejection head 15 to eject the second liquid 15A according to the data of the second liquid generated in the second liquid data generating portion 39 provided in the recording data generating portion 38.

As a result, the ink droplets 14A are ejected onto the curable solution layer 12B to form dots in accordance with pixels of an image being the formation object on the curable solution layer 12B to form the image area, as well as the second liquid 15A is ejected to the non-image area other than the image area on the curable solution layer 12B.

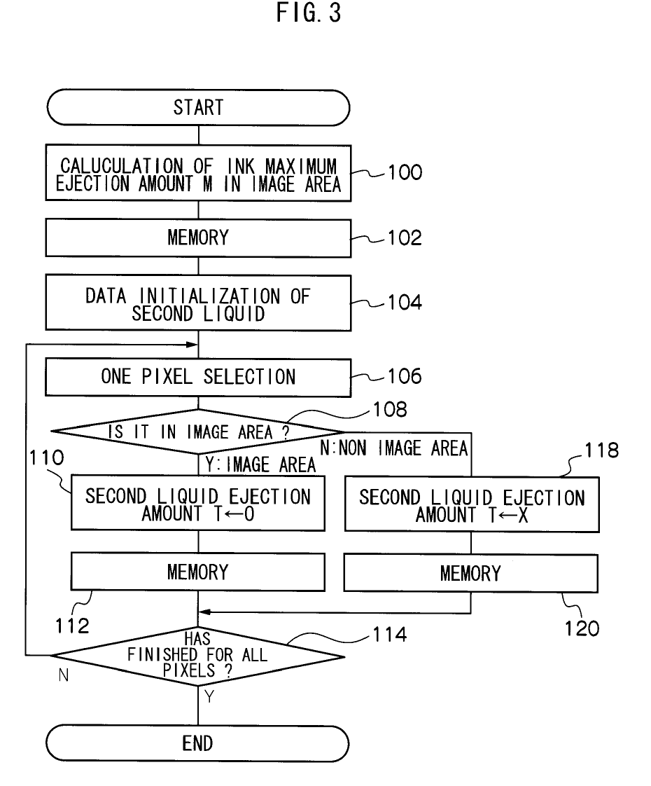

Next, as the action of the embodiment, the generation of data of the second liquid executed in the second liquid data generating portion 39 is described using FIG. 3.

Firstly, at a step 100, the maximum ejection amount M of an ink in an image area T formed on the curable solution layer 12B is calculated.

The processing at the step 100 is a processing for searching a dot to be formed by ejecting the largest amount of the ink droplets 14A among dots constituting the image area formed on the curable solution layer 12B on the basis of image data binarized for respective YMCK colors of respective pixels in the image processing portion 36 and calculating the total amount of the ink droplets 14A of YMCK to be ejected for recording the searched dot.

In the embodiment, it is described that binarization (no ejection, or ejection in a normal amount) is performed for each of YMCK colors of respective pixels in the image processing portion 36.

In the case where the dot for which the largest amount of ink droplets are ejected among dots constituting an image area formed on the curable solution layer 12B is a dot to be formed by the ejection of inks of three colors among the ink droplets 14A of respective YMCK colors in an normal amount, for example, when designating the normal amount as 100%, an ejection amount of 300% being three times (three times as large as the normal amount (amount for three colors)) is calculated as the maximum ejection amount M of the ink. In the embodiment, the description is performed while defining the maximum amount of the ink droplets 14A to be driven to the identical dot is the ejection amount of 300%.

The calculation processing of the maximum ejection amount M of the ink at the step 100 is performed by a calculation portion 39A provided in the second liquid data generating portion 39.

At a subsequent step 102, information showing the maximum ejection amount M of the ink calculated at the step 100 is stored in a memory 39B.

At a subsequent step 104, the data of the second liquid stored in the memory 39B are initialized. The data of the second liquid are data defining the amount of the second liquid for respective areas in accordance with respective pixels in areas corresponding to the recording medium P being the formation object on the curable solution layer 12B formed on the intermediate transfer belt 10.

In the embodiment, as for the amount of the second liquid, four kinds (four gradations), namely, three times as large as the normal amount, two times as large as the normal amount, one time as large as the normal amount (normal amount), and nothing, are set, which are represented by “3,” “2,” “1” and “0”, respectively.

At the step 104, all the data of second liquid for each of dots in accordance with respective pixels in an area corresponding to the recording medium P on the curable solution layer 12B are set “0” to perform the initialization. As a result, for respective dots of respective pixels in all the area corresponding to the recording medium P being the object for image formation, the ejection of the second liquid is set null in the recording apparatus 101.

At a step 106, one pixel, which is not selected for calculating the ejection amount of the second liquid 15A among respective pixels of image data having been inputted to the color converting portion 34 and binarized in the image processing portion 36 (such as a pixel at an i row and a j column of image data), is selected.

The selection at the step 106 is possible, for example, by selecting one of pixels that are stored in a memory 39B with no association with data showing the ejection amount of the second liquid, among respective pixels of image data binarized in the image processing portion 36.

At a subsequent step 108, whether or not the pixel selected at the step 106 is a pixel corresponding to the dot that forms the image area T when formed on the curable solution layer 12B is estimated. As for the estimation at the step 108, for example, it is sufficient to estimate whether or not at least one of ejection amounts of the ink droplets 14A for respective YMCK colors for recording a dot corresponding to the pixel selected at the step 106 among image data binarized in the image processing portion 36 for respective YMCK colors of respective pixels is “1” that shows the normal ejection amount, and, when at least one is “1” that shows the normal ejection amount, to estimate that it is a pixel corresponding to the image area T. When all the binarized data are “0” that shows no ejection of respective ink droplets 14A of respective YMCK colors for recording a dot corresponding to the pixel selected at the step 106, it is sufficient to estimate that the pixel corresponds to the non-image area.

When affirmed at the step 108, that is, when the pixel just selected at the step 106 is a pixel corresponding to the dot forming the image area T when formed to the curable solution layer 12B, the routine advances to a step 110.

At the step 110, “0” showing no ejection is set as the ejection amount T of the second liquid 15A to be ejected to the area corresponding to the selected pixel.

In a subsequent step 112, the ejection amount T of the second liquid 15A set at the step 110 and information (such as an i row and a j column) showing the corresponding selected pixel are associated to be stored in the memory 39B.

As a result of the processing at steps 108, 110 and 112, data of the second liquid, which show that no second liquid 15A is ejected to dots corresponding to respective pixels of the image area on the curable solution layer 12B, have been generated.

At a subsequent step 114, whether or not the setting of the ejection amount T of the second liquid 15A has terminated is estimated for all the pixels among respective pixels of image data binarized in the image processing portion 36. When affirmed, the routine terminates, or when denied, it returns to the step 106.

On the other hand, when denied at the step 108 and the selected pixel corresponds to the non-image area, the routine advances to a step 118.

At the step 118, as the ejection amount T of the second liquid 15A to be ejected to the area corresponding to the selected pixel, on the basis of the maximum ejection amount M of the ink calculated at the step 100, an ejection amount X corresponding to the maximum ejection amount M of the ink is read out from the memory 39B and the read out value “X” is set as the ejection amount T of the second liquid 15A.

At a subsequent step 120, the ejection amount T of the second liquid 15A set at the step 118 and the information (such as an i row and a j column) showing the corresponding selected pixel are associated to be stored in the memory 39B. Then, the routine advances to the step 114.

It is sufficient that “X” being the ejection amount of the second liquid 15A set at the step 118 is such an amount that suppresses the irregularity between the image area T formed on the curable solution layer 12B by the ejection of the ink droplets 14A and the non-image area B other than the image area T. Accordingly, “X” being the ejection amount of the second liquid 15A may be determined in accordance with the maximum ejection amount M of the ink calculated at the step 100. Specifically, the ejection amount “X” is satisfactorily set by previously storing the ejection amount X having a value not more than the maximum ejection amount M of the ink calculated at the step 100 and corresponding to the maximum ejection amount M of the ink, and by reading out the value of the ejection amount X corresponding to the maximum ejection amount M of the ink calculated at the step 100.

For example, “1” showing the normal amount (ejection amount at 100%) as “X” being the ejection amount of the second liquid 15A and information showing the normal amount (ejection amount at 100%) as the maximum ejection amount M of the ink calculated at the step 100 are previously associated and stored in the memory 39B.

Further, “2” showing two times as large as the normal amount (ejection amount at 200%), or “1” showing the normal amount (100%) as “X” being the ejection amount of the second liquid 15A and information showing two times as large as the normal amount (ejection amount at 200%) as the maximum ejection amount M of the ink calculated at the step 100 are previously associated and stored in the memory 39B.

Again, “2” showing two times as large as the normal amount (ejection amount at 200%) as the “X” being the ejection amount of the second liquid 15A and information showing three times as large as the normal amount (ejection amount at 300%) as the maximum ejection amount M of the ink calculated at the step 100 are previously associated and stored in the memory 39B.

As described above, by storing the value of “X” corresponding to the maximum ejection amount M of the ink in the memory 39B, for example, in the case where the maximum ejection amount M of the ink calculated at the step 100 is the normal amount “1,” “1” showing the normal amount corresponding to the maximum ejection amount M of the ink, or “0” showing no ejection is read out from the memory 39B, and “X” being the ejection amount of the second liquid 15A in accordance with the maximum ejection amount M of the ink is suitably determined.

As a result of the processing at steps 108, 118 and 120, data of the second liquid, which show the ejection of the second liquid 15A in an ejection amount of the value X to the area corresponding to respective pixels of the non-image area on the curable solution layer 12B, has been created.

As a result of the execution of steps 100-120 in the second liquid data generating portion 39, data of the second liquid are generated.

Then, as described above, by ejecting the ink droplets 14A from the nozzle of inkjet recording heads 14 for respective colors in the image recording portion 40 according to recording data of YMCK created in the recording data generating portion 38, dots in accordance with pixels of an image being the formation object are formed on the curable solution layer 12B to form the image area T.

Then, to the non-image area other than the image area T on the curable solution layer 12B, according to the data of the second liquid generated in the second liquid data generating portion 39 provided in the recording data generating portion 38, the second liquid 15A is ejected from the nozzle of the second liquid ejection head 15 in the ejection amount of X set at the step 118.

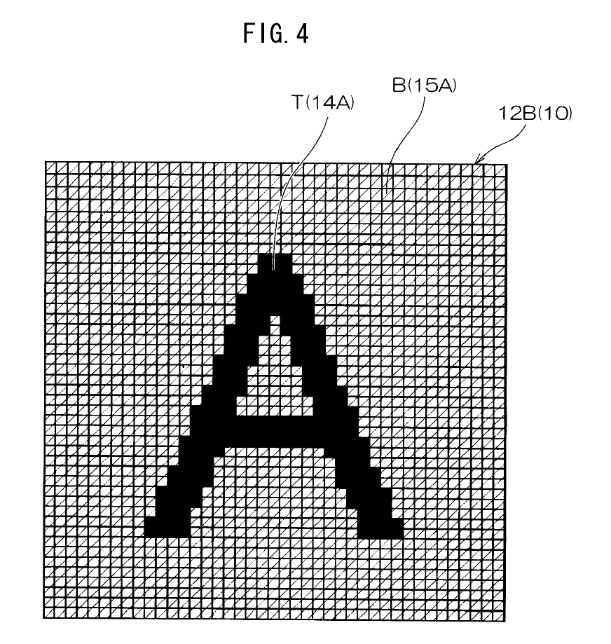

Consequently, as shown in FIG. 4, the non-image area B other than the image area T formed by the ejection of the ink droplets 14A on the curable solution layer 12B formed on the intermediate transfer belt 10 is in a state in which the second liquid 15A in an ejection amount of X has been ejected to areas corresponding to respective pixels.

When areas of the curable solution layer 12B to which the ink droplets 14A and the second liquid 15A have been ejected reach the position provided with the transfer device 16 by the turn of the intermediate transfer belt 10, as described above, the layer is nipped by the pressure rolls 16A and 16B to apply pressure, and, then, to the position (peeling position) nipped by the support roll 10C and the support 22, a state in which the curable solution layer 12B contacts with both the intermediate transfer belt 10 and recording medium P is maintained. Then, caused by supplying a stimulus to the curable solution layer 12B in the state of contacting with both the intermediate transfer belt 10 and the recording medium P by the stimulus supply device 18 via the intermediate transfer belt 10, the curable solution layer 12B cures. Then, by the peeling of the curable solution layer 12B from the intermediate transfer belt 10 at the peeling position, a cured resin layer (image layer), on which the image area T by the ink droplets 14A is formed, is formed on the recording medium P.

Here, when the ink droplets 14A are ejected onto the curable solution layer 12B by the inkjet recording head 14, the volume of the curable solution layer 12B increases due to the absorption of the ink by a liquid absorbing resin described later in the curable solution layer 12B. Consequently, the thickness of an area on the curable solution layer 12B to which the ink droplets 14A are ejected is thicker than that in areas to which the ink droplets 14A are not ejected.

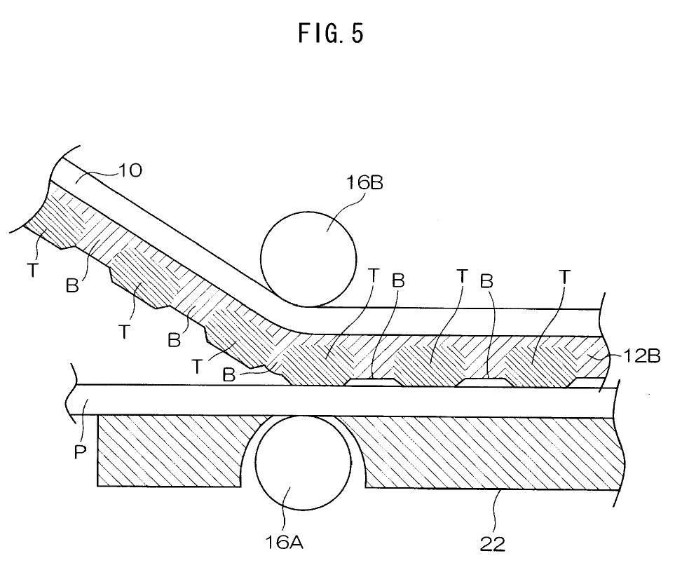

Consequently, the image area T is formed on the curable solution layer 12B by ejecting the ink droplets 14A in accordance with an image onto the curable solution layer 12B, and, when no second liquid 15A is ejected in contrast to the recording apparatus 101 of the embodiment, it is considered that the difference between the thicknesses of the image area T and non-image area B on the intermediate transfer belt 10 is greater than that in the case where the second liquid 15A is ejected, to cause a state in which irregularity is formed on the surface, as shown in FIG. 5.

In the state in which irregularity is formed on the surface of the curable solution layer 12B in this way, the adhesion between the curable solution layer 12B and the recording medium P at the transfer to the recording medium P by the pressure rolls 16A and 16B is occasionally hindered by the irregularity.

On the other hand, according to the recording apparatus 101 of the embodiment, since the second liquid 15A is ejected to the non-image area B other than the image area T formed by dots recorded by ejecting the ink droplets 14A onto the curable solution layer 12B in an amount in accordance with the maximum amount M of the ink in the image area T formed on the curable solution layer 12B, the liquid absorbing resin in the non-image area B of the curable solution layer 12B absorbs the second liquid 15A to swell the curable solution layer 12B to cause the increase in the volume. In addition, for the image area T, too, the liquid absorbing resin in the image area T of the curable solution layer 12B absorbs the ink droplets 14A to swell the curable solution layer 12B to cause the increase in the volume. Consequently, in a similar manner to the image area T having absorbed the ink droplets 14A, the thickness of the non-image area B is also increased as compared with the thickness before the absorption due to the absorption of the second liquid 15A. Consequently, as compared with the case where no second liquid 15A is ejected to the non-image area B, the difference between thicknesses of the image area T and the non-image area B on the surface of the curable solution layer 12B is suppressed.

This improves, accordingly, the adhesion between the curable solution layer 12B and the recording medium P at the transferring of the curable solution layer 12B to the recording medium P by the pressure rolls 16A and 16B.

Further, when the second liquid 15A is not ejected to the non-image area B, since the curable solution layer 12B is transferred to the recording medium P being nipped by the pressure rolls 16A and 16B to apply pressure, it is necessary to apply a high pressure (for example, 10 kPa or more (50 kPa or less)) in view of the difference in the layer thickness between the image area T and the non-image area B. However, although a higher pressure further improves the adhesion between the curable solution layer 12B and the recording medium P, occasionally the ink of respective dots constituting the image area T formed on the curable solution layer 12B protruded towards the outside of the image area T to generate image defect.

On the other hand, in the recording apparatus 101 of the embodiment, since the second liquid 15B is ejected onto the non-image area B, the difference in the layer thickness between the image area T and the non-image area B on the curable solution layer 12B is suppressed, as compared with the case where the second liquid 15A is not ejected. Consequently, it is considered that the pressure applied by the pressure rolls 16A and 16B may be reduced as compared with the case where the second liquid 15A is not ejected. Accordingly, the recording apparatus 101 of the embodiment realizes both the improvement in the adhesion between the recording medium P and the curable solution layer 12B, and the improvement in the suppression of image defect.

Further, since the second liquid 15A is ejected to areas corresponding to respective pixels of the non-image area B of the curable solution layer 12B in an amount being above the minimum ejection amount and equal to or less than the maximum ejection amount M of the ink in the image area T, the difference in the thickness between the image area T and the non-image area B is effectively suppressed as compared with the case where the second liquid 15A is not ejected to the non-image area B, and the improvement in the adhesion between the recording medium P and the curable solution layer 12B can be achieved effectively.

Furthermore, the embodiment is constituted so that the ink droplets 14A are selectively applied from the inkjet recording heads 14 of respective black, yellow, magenta and cyan colors on the basis of image data to record an image of full color on the recording medium P. But it is not limited to the recording of characters and images onto the recording medium P. That is, the apparatus according to the invention is applied to general drop supply (injection) apparatuses used industrially, methods for forming an image by transferring using a plate, methods for forming an image with screen printing, and the like.

Curable Solution

Hereinafter, details of the curable solution 12A is described.

The curable solution 12A contains at least a curable resin that cures by an external stimulus (energy). Here, the “curable resin that cures by an external stimulus (energy)” contained in the curable solution 12A means a material that cures by an external stimulus to become “a cured resin.” Specific examples thereof include curable monomers, curable macromers, curable oligomers, curable prepolymers, and the like.

Examples of the curable resin include an ultraviolet curable resin, an electron beam curable resin, and a thermally curable resin. The ultraviolet curable resin is most preferable, since the ultraviolet curable resin easily cures, the curing speed is faster than the other materials, and the handling is easy. The electron beam curable resin does not require a polymerization initiator, and control of coloration of the cured layer is easy. The thermally curable resin cures without requiring any large apparatus. The curable resin is not limited to these, and a curable resin which cures by, for example, moisture, oxygen, or the like may be applied.

Examples of the “ultraviolet cured resin” obtained by curing the ultraviolet curable resin include an acrylic resin, a methacrylic resin, a urethane resin, a polyester resin, a maleimide resin, an epoxy resin, an oxetane resin, a polyether resin, and a polyvinyl ether resin. The curable solution 12A containing the ultraviolet curable resin includes at least one of an ultraviolet curable monomer, an ultraviolet curable macromer, an ultraviolet curable oligomer, and an ultraviolet curable prepolymer. The curable solution 12A preferably includes an ultraviolet polymerization initiator to make the ultraviolet curing reaction proceed. Further, the curable solution 12A may include, if necessary, a reaction aid, or a polymerization promoter, which promotes the polymerization reaction.

Examples of the ultraviolet curable monomer include radical curable materials such as an acrylate of an alcohol, a polyalcohol, or an aminoalcohol, a methacrylate of an alcohol, or a polyalcohol, an acryl aliphatic amide, an acryl alicyclic amide, and an acryl aromatic amide; cationic curable materials such as an epoxy monomer, an oxetane monomer, and a vinyl ether monomer. Examples of the ultraviolet curable macromer, the ultraviolet curable oligomer, and the ultraviolet curable prepolymer include, in addition to those obtained by polymerizing these monomers at a predetermined polymerization degree, radical curable materials such as an epoxy acrylate, urethane acrylate, polyester acrylate, polyether acrylate, urethane methacrylate, or polyester methacrylate in which an acryloyl group or a methacryloyl group is added to an epoxy, urethane, polyester, or polyether skeleton.

In the case where the curing reaction is a radical curing reaction, examples of the ultraviolet polymerization initiator include benzophenones, thioxanthones, benzyl dimethyl ketals, α-hydroxy ketones, α-hydroxyalkyl phenones, α-amino ketones, α-aminoalkyl phenones, monoacylphosphine oxides, bisacylphosphine oxides, hydroxy benzophenones, amino benzophenones, titanocenes, oxime esters, and oxyphenyl acetates.

In the case where the curing reaction is a cationic curing reaction, examples of the ultraviolet polymerization initiator include aryl sulfonium salts, aryl diazonium salts, diaryl iodonium salts, triaryl sulfonium salts, allene-ion complex derivatives, and triazines.

Examples of the “electron beam cured resin” obtained by curing the electron beam curable material include an acrylic resin, a methacrylic resin, a urethane resin, a polyester resin, a polyether resin, and a silicone resin. The curable solution 12A containing the electron beam curable resin includes at least one of an electron beam curable monomer, an electron beam curable macromer, an electron beam curable oligomer, and an electron beam curable prepolymer.

Examples of the electron beam curable monomer, macromer, oligomer, or prepolymer include materials similar to the ultraviolet curable materials.

Examples of the “thermally cured resin” obtained by curing the thermally curable material include an epoxy resin, a polyester resin, a phenol resin, a melamine resin, a urea resin, and an alkyd resin. The curable solution 12A containing the thermally curable resin includes at least one of a thermally curable monomer, a thermally curable macromer, a thermally curable oligomer, and a thermally curable prepolymer. A curing agent may be added at polymerization. The curable solution 12A may include a thermal polymerization initiator to make the thermal curing reaction proceed.

Examples of the thermally curable monomer include phenol, formaldehyde, bisphenol A, epichlorohydrin, cyanuric acid amide, urea, and polyalcohols such as glycerin, and acids such as phthalic anhydride, maleic anhydride, and adipic acid. Examples of the thermally curable macromer, oligomer, and prepolymer include those obtained by polymerizing these monomers at a predetermined polymerization degree, an epoxy prepolymer, and a polyester prepolymer.

Examples of the thermal polymerization initiator include acids such as proton acid/Lewis acid, alkaline catalysts, and metal catalysts.

As mentioned above, the curable resin may be any material as long as it cures (for example, through a polymerization reaction) by an external energy such as ultraviolet rays, electron beams, or heat.

Among the above-mentioned curable resins, in view of high speed image recording, a material which cures at a high curing speed (such as a material of which polymerization reaction speed is high) may be used. Examples of such curable resin include a radiation curing material (such as the ultraviolet curable resin and the electron beam curable resin).

The curable resin may have been modified by Si, fluorine or the like in view of wettability with respect to the intermediate transfer member. Further, the curable resin preferably contains a polyfunctional prepolymer in view of the curing speed and curing degree.

The curable solution may contain water or an organic solvent for dissolving or dispersing main components (such as monomer, macromer, oligomer and prepolymer, and a polymerization initiator) that contribute to the curing reaction. But, the ratio of the main components is, for example, 30% by weight or more, preferably 60% by weight or more, and more preferably 90% by weight or more.

The curable solution may also contain various colorants for the purpose of controlling the coloration of the cured layer.

The curable solution has a viscosity in the range of from 5 mPa·s to 10000 mPa·s, preferably from 10 mPa·s to 1000 mPa·s, and more preferably from 15 mPa·s to 500 mPa·s. Further, the viscosity of the curable solution is favorably higher than the viscosity of the ink.

The curable solution 12A preferably contains a material that fixes the colorant in the ink.

As the material, a material having liquid absorbing properties (liquid absorbing material) for the ink is preferable. The liquid absorbing material means such a liquid absorbing material that, when the liquid absorbing material and the ink are mixed at a weight ratio of 30:100 for 24 hours and then the liquid absorbing material is taken out from the mixture liquid with a filter, the weight of the liquid absorbing material increases by 5% or more relative to that before mixing with the ink.

Thus, by including the ink liquid absorbing material in the curable solution 12A, the liquid components of the ink (such as water and an aqueous solvent) are quickly taken into the resin layer to fix an image. Therefore, color mixture at the boundary portion between inks, unevenness of an image, and, furthermore, uneven transferring of the ink by the pressure at the transferring are reduced.

Examples of the liquid absorbing material include resin (hereinafter, occasionally referred to as a liquid absorbing resin), inorganic particles (such as silica, alumina and zeolite) provided with the surface having ink attracting properties, and the like, which are suitably selected in accordance with an ink to be used.

Specifically, when an aqueous ink is used as the ink, a water absorbing material is preferably used as the liquid absorbing material. When an oil-based ink is used as the ink, an oil absorbing material is preferably used as the liquid absorbing material.

Specific examples of the water absorbing material include polyacrylic acid or salts thereof, polymethacrylic acid or salts thereof, a copolymer including (meth)acrylic acid ester-(meth)acrylic acid or a salt thereof, a copolymer including styrene-(meth)acrylic acid or a salt thereof, a copolymer including styrene-(meth)acrylic acid ester-(meth)acrylic acid or a salt thereof, a copolymer including styrene-(meth)acrylic acid ester-(meth)acrylic acid ester wherein the ester group thereof has an aliphatic or aromatic substituent having a structure of carboxylic acid or a salt thereof, a copolymer including (meth)acrylic acid ester-(meth)acrylic acid ester wherein the ester group thereof has an aliphatic or aromatic substituent having a structure of carboxylic acid or a salt thereof, an ethylene-(meth)acrylic acid copolymer, a copolymer including butadiene-(meth)acrylic acid ester-(meth)acrylic acid or a salt thereof, a copolymer including butadiene-(meth)acrylic acid ester-(meth)acrylic acid ester wherein the ester group thereof has an aliphatic or aromatic substituent having a structure of carboxylic acid or a salt thereof, polymaleic acid or a salt thereof, a copolymer including styrene-maleic acid or a salt thereof, resins obtained by modifying any of the above resins with sulfonic acid, and resins obtained by modifying any of the above resins with phosphoric acid. Preferable examples include polyacrylic acid and salts thereof, a copolymer including styrene-(meth)acrylic acid or a salt thereof, a copolymer including styrene-(meth)acrylic acid ester-(meth)acrylic acid or a salt thereof, a copolymer including styrene-(meth)acrylic acid ester-(meth)acrylic acid ester wherein the ester group thereof has an aliphatic or aromatic substituent having a structure of carboxylic acid or a salt thereof, and a copolymer including (meth)acrylic acid ester-(meth)acrylic acid or a salt thereof. The resins may be crosslinked, or may be not crosslinked.

Further, specific examples of the oil absorbing material include low molecular weight gelling agent such as hydroxystearic acid, cholesterol derivatives, and benzylidene sorbitol, polynorbornene, polystyrene, polypropylene, a styrene-butadiene copolymer and various rosins. Preferable examples include polynorbornene, polypropylene, and rosins.

When the liquid absorbing material is in the form of particles, the volume average particle diameter thereof is preferably in the range of from 0.05 μm to 25 μm, and more preferably from 0.05 μm to 5 μm, from the standpoint of satisfying both the stability of the curable solution 12A and image quality.

The weight ratio of the liquid absorbing material relative to the whole curable solution 12A is, for example, 10% or more, preferably 20% or more, and more preferably in the range of from 25% to 70%.

Other additives contained in the curable solution 12A are described.

The curable solution 12A may contain a component that flocculates the ink component or thickens the ink.

The component having the function may be contained either as a functional group of a resin (water absorbing resin) constituting the liquid absorbing resin particle, or as a compound. Examples of the functional group include carboxylic acid, polyvalent metal cations, polyamines and the like.

Examples of the compound include coagulants such as inorganic electrolytes, organic acids and salts thereof, inorganic acids, and organic amine compounds.

Examples of the inorganic electrolytes include alkali metal ions such as lithium ion, sodium ion, and potassium ion, polyvalent metal ions, such as aluminum ion, barium ion, calcium ion, copper ion, iron ion, magnesium ion, manganese ion, nickel ion, tin ion, titanium ion, and zinc ion; and salts of inorganic acids such as hydrochloric acid, hydrobromic acid, hydroiodic acid, sulfuric acid, nitric acid, phosphoric acid, and thiocyanic acid.

Specific examples of organic acids and salts thereof include organic carboxylic acids such as alginine, citric acid, glycine, glutamic acid, succinic acid, tartaric acid, cysteine, oxalic acid, fumaric acid, phthalic acid, maleic acid, malonic acid, lysine, malic acid, acetic acid, oxalic acid, lactic acid, salycilic acid, benzoic acid; organic sulfonic acids; a compound represented by Formula (1); and derivatives of the above compounds.

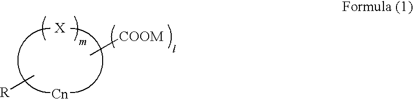

In Formula (1), X represents O, CO, NH, NR₁, S, or SO₂. R₁ represents an alkyl group, and, R₁ is preferably CH₃, C₂H₅, or C₂H₄OH. R represents an alkyl group and R is preferably CH₃, C₂H₅, or C₂H₄OH. R may be contained or not contained in the formula. X is preferably CO, NH, NR₁, or O and, more preferably, CO, NH, or O. M represents a hydrogen atom, an alkali metal or an amine. M is preferably H, Li, Na, K, monoethanolamine, diethanolamine, triethanolamine, or the like, and is more preferably, H, Na, K and, is further preferably, a hydrogen atom; n represents an integer of from 3 to 7, n is preferably such an integer that the heterocycle in the formula is a 6-membered or 5-membered heterocycle, or more preferably, a 5-membered heterocycle; m is 1 or 2. The compound represented by Formula (1) may be a saturated ring or unsaturated ring in a case where the ring is a heterocycle, and l represents an integer of from 1 to 5.

The organic amine compound may be any of a primary amine, a secondary amine, a tertiary amine, a quaternary ammonium; or a salt of a primary, secondary, or tertiary amine; or quaternary ammonium.

More preferable examples of the organic amine compounds include triethanolamine, triisopropanolamine, 2-amino-2-ethyl-1,3-propanediol, ethanolamine, diaminopropane, and propylamine.

Among these coagulants, it is preferable to use polyvalent metal salts such as Ca(NO₃)₂, Mg(NO₃)₂, Al(OH)₃, and polyaluminum chloride.

Only a single coagulant may be used, or a mixture of two or more coagulants may be used. The content of coagulant is preferably within a range of from 0.01% by weight to 30% by weight. The content of coagulant is more preferably in a range of from 0.1% by weight to 15% by weight and further preferably in a range of from 1% by weight to 15% by weight.

Ink

The ink used in the above exemplary embodiments will be described below.

As the ink, any of an aqueous ink containing an aqueous solvent as the solvent, an oil-based ink containing an oil solvent as the solvent, a UV curable ink and a phase-changeable wax ink may be used. In these exemplary embodiments, good image fixability may be obtained without evaporating the solvent by a heater or the like when an aqueous or oil-based ink and an impervious medium as a recording medium are used.

The aqueous ink may be, for example, an ink prepared by dispersing or dissolving a water-soluble dye or pigment as a recording substance in an aqueous solvent. Further, the oil-based ink may be, for example, an ink prepared by dissolving an oil-soluble dye as a recording substance in an oil solvent or an ink prepared by dispersing a dye or pigment as a recording substance by reverse micellation.

When using the oil-based ink, an oil-based ink using a low-volatile or non-volatile solvent, is preferably used. Since the solvent for the oil-based ink is low-volatile or non-volatile, the state of the ink is less likely to be changed by evaporation of the solvent at the end of a head nozzle, head nozzle shows satisfactory clogging resistance. Further, since the solvent for the oil-based ink is low-volatile or non-volatile, curl and cockle are less likely to occur even when the solvent for the oil-based ink penetrates into the recording medium after the curable solution layer that has received the ink droplets is transferred to the recording medium. Further, the solvent for the oil-based ink may be cationically curable.

In the embodiment, an aqueous ink is preferably used as the ink. The use of an aqueous ink can improve the reliability of the inkjet head at the maintenance and at a long period storage, as compared with the use of a ultraviolet curable ink and a phase-changeable ink. In this case, a water absorbing material is preferably used as the liquid absorbing material contained in the curable solution 12A.

First, the recording substance is to be described. A typical recording substance is a colorant. As the colorant, dyes and pigments are both usable; pigments are preferred in view of durability. As the pigment, organic pigments and inorganic pigments are both usable. Exemplary black pigments include carbon black pigments such as furnace black, lamp black, acetylene black, and channel black. Pigments other than black pigments and pigments of three primary colors of cyan, magenta and yellow, are also usable, examples of which include pigments of specific colors such as red, green, blue, brown, and white, metal luster pigments such as pigments of gold color and pigments of silver color, colorless or pale colored body pigments, and plastic pigments. Further, pigments that are synthesized newly for the invention may also be used.

Further, it is also possible to use, as a pigment, particles including silica, alumina, or polymer beads as the core and a dye or pigment fixed to the surface of the core, insoluble lake compound of a dye, a colored emulsion, a colored latex, or the like.

Specific examples of the black pigments include, but are not limited to, Raven 7000 (manufactured by Columbian Chemicals Co.), Regal 400R (manufactured by Cabot Corp.) and Color Black FW1 (manufactured by Degussa Co.).

Specific examples of the cyan pigments include, but are not limited to, C.I. Pigment Blue-1, -2, -3, -15, -15:1, -15:2, -15:3, -15:4, -16, -22, and -60.

Specific examples of magenta pigments include, but are not limited to, C.I. Pigment Red-5, -7, -12, -48, -48:1, -57, -112, -122, -123, -146, -168, -177, -184, -202, and C.I. Pigment Violet-19.

Specific examples of yellow pigments include, but are not limited to, C.I. Pigment Yellow-1, -2, -3, -12, -13, -14, -16, -17, -73, -74, -75, -83, -93, -95, -97, -98, -114, -128, -129, -138, -151, -154, and -180.

When using a pigment as the colorant, a pigment dispersant is preferably used together. Usable pigment dispersants include polymer dispersants, anionic surfactants, cationic surfactants, amphoteric surfactants, and nonionic surfactants.

As the polymer dispersant, a polymer having a hydrophilic structure part and a hydrophobic structure part is preferably used. The polymer having a hydrophilic structure part and a hydrophobic structure part may be a condensation type polymer or an addition polymer. The condensation type polymer may be a known polyester-based dispersant. The addition polymer may be an addition polymer of a monomer having an α,β-ethylenically unsaturated group. A desired polymer dispersant is obtained by copolymerizing a monomer having an α,β-ethylenically unsaturated group having a hydrophilic group and a monomer having an α,β-ethylenically unsaturated group having a hydrophobic group in combination. Further, a homopolymer of a monomer having an α,β-ethylenically unsaturated group having a hydrophilic group is also usable.

The monomer having an α,β-ethylenically unsaturated group having the hydrophilic group may be a monomer having a carboxylic group, a sulfonic group, a hydroxy group, a phosphoric group, etc., examples of which include, acrylic acid, methacrylic acid, crotonic acid, itaconic acid, itaconic acid monoester, maleic acid, maleic acid monoester, fumaric acid, fumaric acid monoester, vinyl sulfonic acid, styrene sulfonic acid, sulfonated vinyl naphthalene, acrylamide, methacryloyloxyethyl phosphate, bismethacryloyloxyethyl phosphate, methacryloyloxyethyl phenyl acid phosphate, ethylene glycol dimethacrylate, and diethylene glycol dimethacrylate.

Preferable examples of the monomer having an α,β-ethylenically unsaturated group having a hydrophobic group include styrene derivatives such as styrene, α-methylstyrene, and vinyltoluene, vinylcyclohexane, vinylnaphthalene, vinylnaphthalene derivatives, alkyl acrylates, alkyl methacrylates, phenyl methacrylates, cycloalkyl methacrylates, alkyl crotonates, dialkyl itaconates, and dialkyl maleates.

Examples of copolymers used as the polymer dispersant include styrene-styrene sulfonic acid copolymers, styrene-maleic acid copolymers, styrene-methacrylic acid copolymers, styrene-acrylic acid copolymers, vinyl naphthalene-maleic acid copolymers, vinylnaphthalene-methacrylic acid copolymers, vinyl naphthalene-acrylic acid copolymers, alkyl acrylate-acrylic acid copolymers, alkyl methacrylate-methacrylic acid copolymers, styrene-alkyl methacrylate-methacrylic acid copolymers, styrene-alkyl acrylate-acrylic acid copolymers, styrene-phenyl methacrylate-methacrylic acid copolymers, styrene-cyclohexyl methacrylate-methacrylic acid copolymers, and vinyl ester-vinyl alcohol copolymers such as vinyl acetate-vinyl alcohol copolymer, or derivatives thereof. Further, monomers having a polyoxyethylene group or a hydroxy group may be copolymerized with the polymers described above.

The polymer dispersant may have a weight average molecular weight of, for example, from 2,000 to 50,000.

Only a single pigment dispersant may be used, or two or more pigment dispersants may be used in combination. Since the amount of pigment dispersant to be added varies greatly according to the pigment used, it cannot be defined uniquely, but the total amount of pigment dispersant to be added is usually from 0.1% by weight to 100% by weight with respect to the amount of pigment.

A pigment that is self-dispersible in water may be used as the colorant. The pigment that is self-dispersible in water refers to a pigment which has many water-solubilizing groups on the surface of the pigment and can disperse in water even in the absence of a polymer dispersant. Specifically, a pigment that is self-dispersible in water may be obtained by subjecting usual pigments to a surface modifying treatment such as an acid/base treatment, a coupling agent treatment, a polymer grafting treatment, a plasma treatment or a redox treatment.

The pigment that is self-dispersible in water may be the pigment prepared by subjecting a pigment to a surface modifying treatment. However, it is also possible to use commercially available self-dispersible pigments such as CAB-O-JET-200, CAB-O-JET-300, IJX-157, IJX-253, IJX-266, IJX-273, IJX-444, IJX-55, CAB-O-JET-260M, CAB-O-JET-250C, CAB-O-JET-270Y, CAB-O-JET-1027R, CAB-O-JET-554B, manufactured by Cabot Co. and Microjet Black CW-1 and CW-2 manufactured by Orient Chemical Co.

The self-dispersible pigment is preferably a pigment having, on the surface thereof, at least sulfonic acid, a sulfonic acid salt, carboxylic acid, or a carboxylic acid salt as a functional group, and is more preferably a pigment having, on the surface thereof, at least carboxylic acid or a carboxylic acid salt as a functional group.

Further, a pigment coated with a resin is also usable. This pigment is referred to as a microcapsule pigment. Usable microcapsule pigments include not only commercially available microcapsule pigments such as those manufactured by Dai-Nippon Ink Chemical Industry Co. and Toyo Ink Co. but also microcapsule pigments manufactured for the invention.

Further, a resin dispersion type pigment in which a polymeric substance is adsorbed physically or bonded chemically to a pigment (, which may be selected from the above pigments) is also usable.

Other examples of the recording substance include dyes such as hydrophilic anion dyes, direct dyes, cation dyes, reactive dyes, polymer dyes, and oil-soluble dyes, a wax powder, resin powder, or emulsion colored with a dye; fluorescent dyes and fluorescent pigments; IR absorbents; UV absorbents; magnetic materials such as ferromagnetic materials such as ferrite or magnetite; semiconductors or photocatalysts such as titanium oxide and zinc oxide; as well as other organic and inorganic electronic material particles.

The content (concentration) of the recording substance is, for example, within a range of from 5% by weight to 30% by weight with respect to the weight of ink.

The volume average particle size of the recording substance is, for example, within a range of from 10 nm to 1,000 nm.

The volume average particle size of the recording substance means the particle size of the recording substance per se, or, in a case where additives such as dispersant are adhered to the recording substance, the particle size of the particle including the adhered additives. A MicroTrack UPA particle size analyzer 9340 (manufactured by Leed & Northrup Co.) is used as the apparatus for measuring the volume average particle size. The measurement is conducted on 4 mL of ink in a measuring cell according to a predetermined measuring method. With respect to the input values upon measurement, the viscosity of the ink is assumed to be the viscosity and the density of the recording substance is assumed to be the density of the dispersed particles.

Next, the aqueous solvent is to be described. The aqueous solvent may be water and, in particular, ion-exchange water, ultrapure water, distilled water, or ultrafiltration water is used preferably. Further, a water-soluble organic solvent may also be used together with the aqueous solvent. Usable water-soluble organic solvents include polyhydric alcohols, polyhydric alcohol derivatives, nitrogen-containing solvents, alcohols, and sulfur-containing solvents.

Specific examples of water-soluble organic solvents include polyhydric alcohols such as ethylene glycol, diethylene glycol, propylene glycol, butylene glycol, triethylene glycol, 1,5-pentanediol, 1,2-hexanediol, 1,2,6-hexanetriol, glycerin, and trimethylol propane, sugar alcohols such as xylitol, and saccharides such as xylose, glucose, and galactose.

Exemplary polyhydric alcohol derivatives include ethylene glyocol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, and ethylene oxide adducts of diglycerin.

Exemplary nitrogen-containing solvents include pyrrolidone, N-methyl-2-pyrrolidone, cyclohexylpyrrolidone, and triethanolamine. Exemplary alcohols include alcohols such as ethanol, isopropyl alcohol, butyl alcohol, and benzyl alcohol.

Exemplary sulfur-containing solvents include thiodiethanol, thiodiglycerol, sulfolane, and dimethylsulfoxide.

Other examples of water-soluble organic solvents include propylene carbonate and ethylene carbonate.

At least one water-soluble organic solvent may be used. The content of water-soluble organic solvent is, for example, within a range of from 1% by weight to 70% by weight.

In the following, the oil solvent is described. The oil solvent may be an organic solvent such as an aliphatic hydrocarbon, an aromatic hydrocarbon, an alcohol, a ketone, an ester, an ether, a glycol, a nitrogen-containing solvent, or a plant oil. Examples of the aliphatic hydrocarbon include n-hexane, cyclohexane, methylhexane, n-octane, methylheptane, dimethylhexane, nonane, and decane, and paraffin solvents such as n-paraffin solvent (e.g., Isopar), iso-paraffin solvents, and cycloparaffin solvents. The aromatic hydrocarbon may be toluene, ethylbenzene, or xylene. The alcohol may be methanol, ethanol, propanol, butanol, hexanol, or benzylalcohol. The ketone may be acetone, methyl ethyl ketone, pentanone, hexanone, heptanone, or cyclohexanone. The ester may be methyl acetate, ethyl acetate, vinyl acetate, ethyl propionate, or ethyl butyrate. The ether may be diethyl ether, ethyl propyl ether, or ethyl isopropyl ether. The glycol may be ethylene glycol, diethylene glycol, propanediol, hexanediol, glycerin, or polypropylene glycol. It is also possible to use a glycol derivative such as ethylene glycol methyl ether, ethylene glycol ethyl ether, ethylene glycol butyl ether, diethylene glycol ethyl ether, or diethylene glycol butyl ether as the solvent. The plant oil may be a drying oil, a semi-drying oil, or a non-drying oil. Exemplary drying oils include perilla oil, linseed oil, tung oil, poppy seed oil, walnut oil, safflower oil, and sunflower oil. Exemplary semi-drying oils include rapeseed oil, and exemplary non-drying oils include palm oil. Only one oil solvent may be used, or two or more oil solvents may be used in combination.

Other additives are described below. A surfactant may be added to the ink, as necessary.

Usable surfactants include various anionic surfactants, nonionic surfactants, cationic surfactants, and amphoteric surfactants. Anionic surfactants and nonionic surfactants are preferable.

Only a single surfactant may be used, or a mixture of plural surfactants may be used. Further, the hydrophilic/hydrophobic balance (HLB) of the surfactant may be, for example, within the range of from 3 to 20 in view of the solubility or the like.

The addition amount of the surfactant is, for example, from 0.001% by weight to 5% by weight and, preferably, from 0.01% by weight to 3% by weight.

To the ink, the following agents may be added: for adjusting the permeability, penetrants; for controlling the properties such as improvement of the ink ejection property, polyethyleneimine, polyamines, polyvinyl pyrrolidone, polyethylene glycol, ethyl cellulose, carboxymethyl cellulose, etc.; for adjusting the conductivity and pH, alkali metal compounds such as potassium hydroxide, sodium hydroxide, lithium hydroxide; and, as necessary, pH buffers, antioxidants, mold inhibitors, viscosity adjusting agents, conductive agents, UV-absorbers, chelating agents, etc.

Next, exemplary properties of the ink are described. The surface tension of the ink is, for example, in the range of from 20 mN/m to 45 mN/m.

The surface tension mentioned above is a value obtained by a measurement with a Wilhelmy type surface tension meter (manufactured by Kyowa Interface Science Co., Ltd.) in an environment of 23° C. and 55% RH.

The viscosity of the ink may be from 1.5 mPa·s to 30 mPa·s and, preferably, from 1.5 mPa·s to 20 mPa·s. From the viewpoint of the head ejection property, the ink viscosity is preferably 20 mPa·s or less. Further, the viscosity of the ink is preferably lower than the viscosity of the curable solution.

The viscosity mentioned above is a value obtained by a measurement with a RHEOMAT 115 (manufactured by Contraves Co.) as the measuring apparatus under a condition of a measuring temperature of 23° C. and a shear rate of 1400 s⁻¹.

The ink is not restricted to the constitution described above. Other than the recording substance, the ink may contain functional materials, such as liquid crystal materials and electronic materials.

Second Liquid

Hereinafter, details of the second liquid are described.

As the second liquid, as describe above, a liquid, which has a hue (such as white and transparent) that does not influence the hue of the image area T formed by the ink droplets 14A and adjusts the surface irregularity of the curable solution layer 12B by being ejected to the curable solution layer 12B, is sufficient. Preferably, the swelling degree of the curable solution layer 12B with respect to the second liquid 15A is similar to the swelling degree of the curable solution layer 12B with respect to the ink droplets 14A.

Herein, “similar to the swelling degree” means that, when designating one of the swelling degrees as 100%, the difference in the swelling degrees is within a range of −20% to +20%.

The swelling degree of the curable solution layer 12B is the ratio of change in the layer thickness of the curable solution layer 12B before and after the ejection of the ink droplets 14A or the second liquid 15A, which is a value calculated by Formula (1) below while denoting the measured value before the swelling as film thickness 1 and denoting the measured value after the swelling as film thickness 2. This is sufficient that the ejection amounts of the ink droplets 14A and the second liquid 15A for measuring the swelling degree are the same.

(Swelling degree)={(film thickness 2)/(film thickness 1)}×100[unit: %] Formula (1)

Examples of such second liquid include an embodiment prepared by removing a recording substance (pigment or dye) from the ink described above.

When an aqueous ink is used for ink droplets 14A ejected from the inkjet recording head 14 of the recording apparatus 101, an aqueous second liquid is preferably used. When an oil-based ink is used for the ink droplets 14A ejected from the inkjet recording head 14, an oil-based second liquid is preferably used.

Specifically, examples of the aqueous second liquid include an aqueous solvent. Examples of the oil-based second liquid include an oil solvent.

The aqueous solvent includes aqueous solvents described above as a component of the aqueous ink. The oil solvent includes oil solvents described above as a component of the oil-based ink.

As a solvent for use in the second liquid, the same solvent (aqueous solvent or oil solvent) as the solvent contained in the ink droplets 14A ejected from the inkjet recording head 14 provided in the identical recording apparatus is preferably used in order to suppress the generation of the difference in the degree of swelling due to the liquid absorption of the curable solution layer 12B.

To these aqueous solvent or oil solvent, similar to the case of the ink, there may be added additives such as a surfactant; a penetrant for the purpose of adjusting permeability; polyethylene imine, polyamines, polyvinyl pyrrolidone, polyethylene glycol, ethyl cellulose, carboxymethyl cellulose or the like for the purpose of controlling properties such as improving ejection properties; a compound of an alkali metal such as potassium hydroxide, sodium hydroxide or lithium hydroxide for adjusting conductivity and pH; and, according to need, a pH buffer, an antioxidant, a mold inhibitor, a viscosity adjusting agent, a conductive agent, an ultraviolet absorber, and a chelating agent. Examples of the surfactant include surfactants mentioned as the additive to be added to the ink droplets 14A.

As an additive for use in the second liquid, the use of the same additive in the same content as the additive contained in the ink droplets 14A is preferable in order to suppress the generation of the difference in the degree of swelling due to the liquid absorption of the curable solution layer 12B.

The surface tension and viscosity of the second liquid are each preferably the same as or similar within the range of −20% to +20% to those of the ink droplets 14A ejected from the inkjet recording head 14 of the identical recording apparatus 101, respectively, from the standpoint of suppressing the difference in the degree of swelling due to the liquid absorption of the curable solution layer 12B.

Specifically, the surface tension of the second liquid is, for example, in the range of from 20 mN/m to 45 mN/m. The surface tension means the value measured by a similar method to that for the ink.

The viscosity of the second liquid is in the range of from 1.5 mPa·s to 30 mPa·s, and preferably from 1.5 mPa·s to 20 mPa·s. From the standpoint of head ejection properties, the viscosity of the second liquid is preferably 20 mPa·s or less. Further, the viscosity of the second liquid is preferably lower than the viscosity of the curable solution. The viscosity means the value measured by a similar method to that for the ink.

### Second Embodiment

In the first embodiment, the case where the second liquid 15A is ejected to the non-image area B on the curable solution layer 12B is explained. In the present embodiment, a configuration in which the second liquid 15A is also ejected to the image area T, as well as to the non-image area B on the curable solution layer 12B is explained.

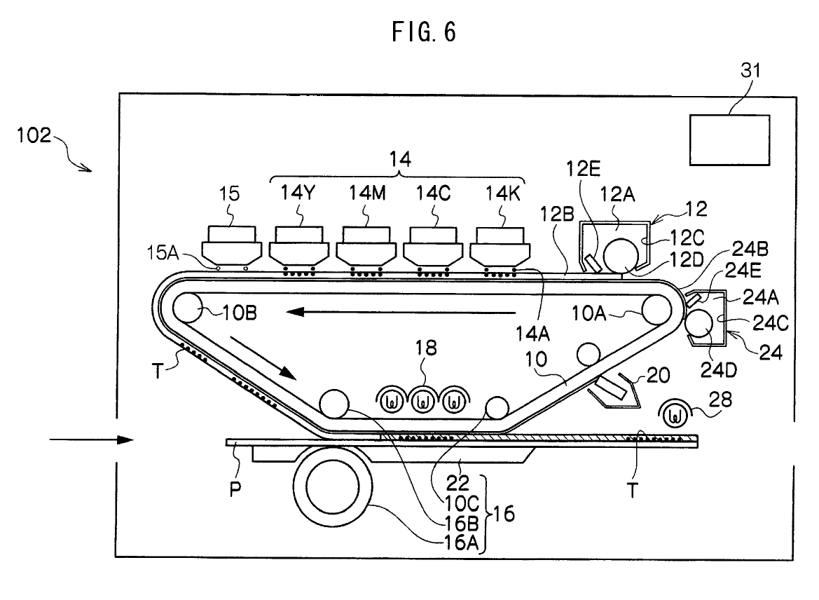

A recording apparatus 102 according to the second embodiment is provided, as shown in FIG. 6, with the intermediate transfer belt 10, the release agent applying device 24, the solution supply device 12 for supplying the curable solution 12A (detailed later) to form the curable solution layer 12B, the inkjet recording head 14 for ejecting the ink droplets 14A in accordance with respective pixels of an image being the formation object onto the curable solution layer 12B formed on the intermediate transfer belt 10 to form dots and to form the image on the curable solution layer 12B, the second liquid ejection head 15 for ejecting the second liquid 15A onto the curable solution layer 12B, the transfer device 16, the stimulus supply device 18, the cleaning device 20, and a main controller 31.

The recording apparatus 102 of the embodiment has a constitution substantially similar to that of the recording apparatus 101 described in the first embodiment, except for being provided with the main controller 31 in place of the main controller 30. Therefore, portions having the same function is given the same symbol and detailed description is omitted.

The main controller 31 controls respective device portions provided in the recording apparatus 102, which is connected to the respective device portions so as to be capable of sending/receiving signal, which is not shown.

The recording apparatus 102 corresponds to the recording apparatus of the invention, and the intermediate transfer belt 10 corresponds to the intermediate transfer member of the recording apparatus of the invention. Further, the solution supply device 12 corresponds to the supplying unit of the recording apparatus of the invention, and the inkjet recording head 14 is included in the first ejection unit of the recording apparatus of the invention. The second liquid ejection head 15 is included in the second ejection unit of the recording apparatus of the invention. The transfer device 16 corresponds to the transfer unit of the recording apparatus of the invention, and the stimulus supply device 18 corresponds to the stimulus supplying unit of the recording apparatus of the invention. Further, the main controller 31 corresponds to the control unit of the recording apparatus of the invention, and a calculation portion 41A, which will be described later, provided in the main controller 31 corresponds to the calculation unit of the recording apparatus of the invention.

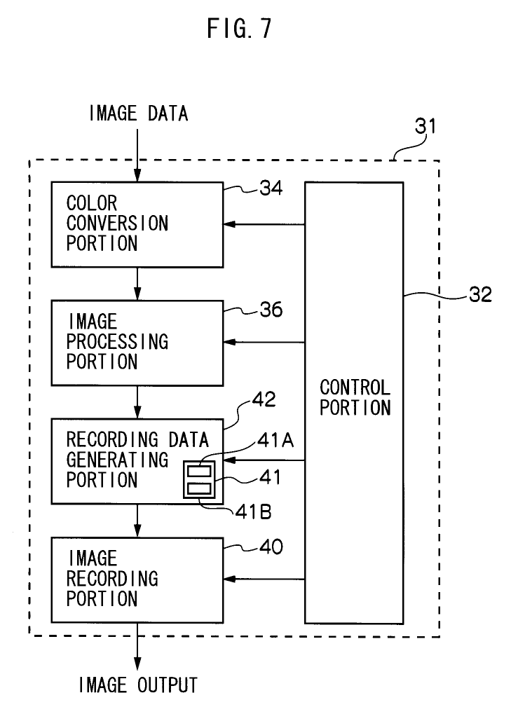

FIG. 7 is a schematic block diagram of the main controller 31. As shown in FIG. 7, the main controller 31 is constituted of at least the control portion 32, the color converting portion 34, the image processing portion 36, a recording data generating portion 42, and the image recording portion 40.

In the recording data generating portion 42, a second liquid data generating portion 41 is provided, in place of the second liquid data generating portion 39 described in the first embodiment. The second liquid data generating portion 41 is constituted of at least a calculation portion 41A and a memory 41B for storing various data.

It is intended that the main controller 31 obtains image data of an object to be recorded with the recording apparatus 102 from an external apparatus via a wireless line or a wire line via an input/output apparatus, which is not shown, provided in the recording apparatus 102. The image data are inputted to the color converting portion 34 described later. Further, in a similar manner to that in the first embodiment, it is intended that the image data inputted to the color converting portion 34 include data of respective pixels of the whole area of the recording medium P being the image formation object. Namely, it is intended that the image data includes data of pixels corresponding to both the image area and the non-image area. It is intended that the data of respective pixels include information showing the position of respective pixels on the recording medium P (such as the position in row direction and the position in column direction) and the color of respective pixels (such as RGB data).

The control portion 32 generally controls the color converting portion 34, the image processing portion 36, the recording data generating portion 42, and the image recording portion 40. In the embodiment, the image recording portion 40 includes a component for recording an image in the recording apparatus 102 described with reference to FIG. 6.

The main controller 31 also has a constitution substantially similar to that described in the first embodiment, except that the second liquid data generating portion 41 is provided in place of the second liquid data generating portion 39. Therefore, the same portions are given the same symbol and detailed description is omitted.

Also in the embodiment, a case, where each of YMCK colors has two gradations, namely, the ink droplets ejected from respective nozzles of inkjet recording heads 14 for respective colors (inkjet recording heads 14Y, 14M, 14C and 14K) have two gradations (namely, no ejection or ejection in anormal amount), is described as one example for simplifying the description, as is similar to the case for the first embodiment.

Further, in the embodiment, regarding the second liquid, too, a case, where the gradation is four in accordance with the kinds of ink droplets ejected from the inkjet recording head 14 as is similar to the case for the first embodiment, is described.

Namely, in the embodiment, a case, where the amount of the second liquid has four types (four gradations) including three times as large as the normal amount, two times as large as the normal amount, one time as large as the normal amount (normal amount) and zero, is described.

The recording data generating portion 42 converts the image data having been binarized for respective YMCK colors of respective pixels in the image processing portion 36 to a data construction that can be decoded by the image recording portion 40, and rearranges data in a recording order (transfer order) to output the resulting data to the image recording portion 40. In this process, the recording data generating portion 42 generates the recording data considering ejection timing and data arrangement associated with the arrangement of inkjet recording heads and nozzles.

Further, the recording data generating portion 42 according to the embodiment creates not only data for the ejection of inks of YMCK four colors, but also data of the second liquid for the ejection of the second liquid to both the image area T formed by dots recorded by the ejection of the ink droplets 14A onto the curable solution layer 12B and the non-image area B other than the image area, on the basis of respective pixel values of image data of a formation object. The data of the second liquid are generated by a second liquid data generating portion 41 provided in the recording data generating portion 42 (details are described later).

The image recording portion 40 allows nozzles of inkjet recording heads 14 for respective colors to eject the ink droplets 14A according to the recording data of YMCK generated in the recording data generating portion 42, as well as it allows the nozzle of the second liquid ejection head 15 to eject the second liquid 15A according to the data of the second liquid generated in the second liquid data generating portion 41 provided in the recording data generating portion 42. As a result, the ink droplets 14A is ejected onto the curable solution layer 12B to form dots in accordance with pixels of an image being the formation object on the curable solution layer 12B to form the image area T, as well as the second liquid 15A is ejected to both the image area T and the non-image area B other than the image area T.

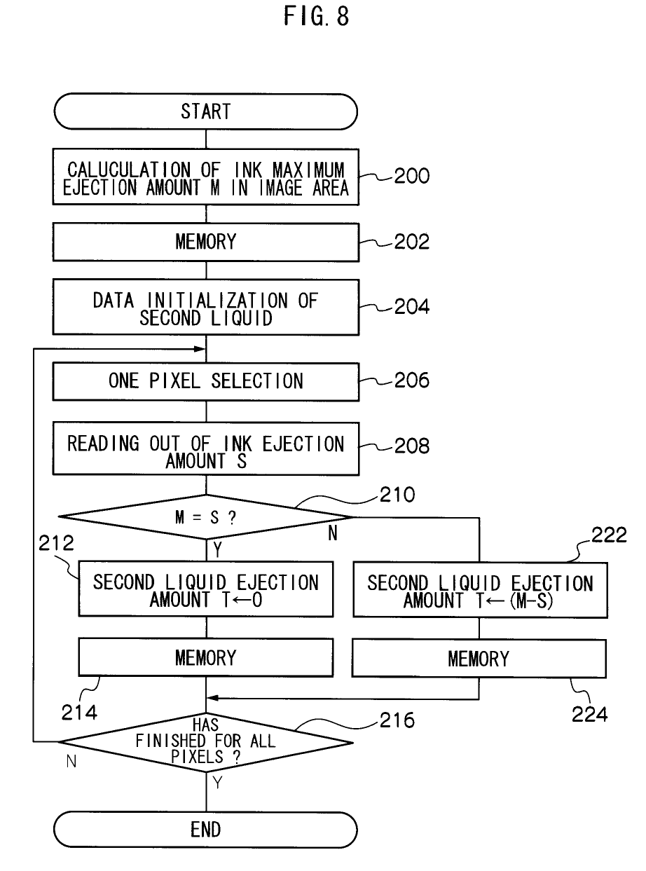

Next, as the action of the embodiment, the generation of data of the second liquid executed in the second liquid data generating portion 41 is explained using FIG. 8.

Firstly, at a step 200, the maximum ejection amount M of the ink in an image area T formed on the curable solution layer 12B is calculated.

The processing at the step 200 is a processing for calculating the total amount of the ink droplets 14A ejected to a dot formed by ejecting the largest amount of the ink droplets 14A among dots constituting the image area formed on the curable solution layer 12B on the basis of image data binarized for respective YMCK colors of respective pixels in the image processing portion 36.

In the embodiment, binarization (no ejection, or ejection in anormal amount) is performed for each of YMCK colors of respective pixels in the image processing portion 36.

For example, in the case where the dot for which the largest amount of ink droplets are ejected among dots constituting an image area formed on the curable solution layer 12B is a dot formed by the ejection of inks of three colors among the ink droplets 14A of respective YMCK colors in an normal amount, when designating the normal amount as 100%, an ejection amount of 300% being three times thereof (three times as large as the normal amount (amount for three colors)) is calculated as the maximum ejection amount M of the ink. In the embodiment, the description is performed while defining the maximum amount of the ink droplets 14A to be driven in the identical one dot is the ejection amount of 300%.

The calculation processing of the maximum ejection amount M of the ink at the step 200 is performed by a calculation portion 41A provided in the second liquid data generating portion 41.

At a subsequent step 202, information showing the maximum ejection amount M of the ink calculated at the step 200 is stored in the memory 41B.

At a subsequent step 204, the data of the second liquid stored in the memory 41B are initialized.

The data of the second liquid are data defining the amount of the second liquid for respective areas in accordance with respective pixels in areas corresponding to the recording medium P being the formation object on the curable solution layer 12B formed on the intermediate transfer belt 10.

The image data include data of pixels corresponding to both the image area and the non-image area, because they are constituted of data showing respective pixels of the whole area corresponding to the recording medium P of the object for image formation.

In the embodiment, as for the amount of the second liquid, four types (four gradations), namely, three times as large as the normal amount, two times as large as the normal amount, one time as large as the normal amount (normal amount), and nothing, are set, which are represented by “3,” “2,” “1” and “0,” respectively.

At the step 204, all the data of second liquid for each of dots in accordance with respective pixels in an area corresponding to the recording medium P on the curable solution layer 12B are set “0” to perform the initialization. As a result, for respective dots of respective pixels in all the area corresponding to the recording medium P being the object for image formation in the recording apparatus 102, the ejection of the second liquid is set null.

At a step 206, one pixel, which is not selected for calculating the ejection amount of the second liquid 15A among respective pixels of image data having been inputted to the color converting portion 34 and binarized in the image processing portion 36, is selected. The selection at the step 206 is possible, for example, by selecting one of pixels (such as a pixel at an i row and a j column of image data) that is stored in a memory 41B with no association with data showing the ejection amount of the second liquid, among respective pixels of image data binarized in the image processing portion 36.

At a subsequent step 208, on the basis of image data binarized in the image processing portion 36, an ink ejection amount S, which is the total amount of the ink droplets 14A ejected for recording a dot corresponding to the pixel selected at the step 206, is read out. The ink ejection amount S is obtained, specifically, by reading out binarized data of each of respective YMCK colors of the pixel selected at the 206 from image data binarized at the image processing portion 36, calculating the total amount of the ejection amount of the ink droplets 14A of respective colors ejected for recording the dot corresponding to the pixel, and reading out the calculated result.

For example, when the dot corresponding to the pixel selected at the step 206 is formed by ejecting the ink droplets 14A of three colors among YMCK four colors in the normal amount, respectively, when designating the normal amount as 100%, the ejection amount of 300% being three times thereof (three times as large as the normal amount (amount for three colors)) is read out as the ink ejection amount S.

At the subsequent step 210, whether or not the maximum ejection amount M of the ink calculated at the step 200 is the same as the ink ejection amount read out at the step 208 is estimated.

When affirmed at the step 210, namely, the maximum ejection amount M of the ink is the same as the ink ejection amount S being the total amount of the ink droplets 14A ejected for recording the dot corresponding to the pixel being the calculation object of the ejection amount of the second liquid, the routine advances to a step 212.

At the step 212, for an ejection amount T of the second liquid 15A ejected onto the area corresponding to the pixel selected as the ejection amount calculation object of the second liquid, “0” showing no ejection is set.

At a subsequent step 214, the ejection amount T of the second liquid 15A set at the step 212 and corresponding information (such as an i row and a j column) showing the pixel selected as the ejection amount calculation object of the second liquid are associated and stored in the memory 41B.

As a result of the processing at steps 210, 212 and 214, data of the second liquid are generated so that the second liquid 15A is not ejected to the dot for which the ejection amount of the ink droplets 14A is the maximum ejection amount M of the ink in the image area T among respective dots constituting the image area T formed on the curable solution layer 12B.

At a subsequent step 216, whether or not the setting of the ejection amount T of the second liquid 15A has terminated is estimated for all the pixels among respective pixels of image data binarized in the image processing portion 36. When affirmed, the routine terminates, or when denied, it returns to the step 206.

On the other hand, when denied at the step 210, namely, the ink ejection amount S being the total amount of the ink droplets 14A ejected for recording the dot corresponding to the pixel of the calculation object of the ejection amount of the second liquid is different from the maximum ejection amount M of the ink, the routine advances to a step 222.

At the step 222, a value obtained by subtracting the ink ejection amount S read out at the step 208 from the maximum ejection amount M of the ink calculated at the step 200 is set as the ejection amount T of the second liquid 15A ejected to the area corresponding to the pixel selected as the ejection amount calculation object of the second liquid.

At a subsequent step 224, the ejection amount T of the second liquid 15A set at the step 222 and the corresponding information (such as an i row and a j column) showing the pixel selected as the ejection amount calculation object of the second liquid are associated and stored in the memory 41B.

As a result of the processing at steps 210, 222 and 224, the ejection amount of the second liquid 15A is determined so that the total amount of the ink droplets 14A and the second liquid 15A ejected to the identical dot is the same amount as the maximum ejection amount M of the ink, for dots in the image area T having a smaller ejection amount of the ink droplets 14A than the maximum ejection amount M of the ink among respective dots constituting the image area T formed on the curable solution layer 12B.

Further, as a result of the processing at steps 210, 222 and 224, in the non-image area B other than the image area T formed on the curable solution layer 12B, the same ejection amount as the maximum ejection amount M of the ink is determined as the ejection amount of the second liquid 15A for the area corresponding to respective pixels of the non-image area B.

As a result of the execution of the processing of step 200-step 224 in the second liquid data generating portion 41, data of the second liquid are generated.

Then, as described above, the ejection of the ink droplets 14A from nozzles of the inkjet recording heads 14 for respective colors in the image recording portion 40 according to recording data of YMCK formed in the recording data generating portion 42 forms dots corresponding to pixels of an image being a formation object on the curable solution layer 12B to form the image area T.

Then, to both the image area T and the non-image area B other than the image area T on the curable solution layer 12B, the second liquid 15A is ejected from the nozzle of the second liquid ejection head 15 in the ejection amount of X set at the step 222, according to the data of the second liquid generated in the second liquid data generating portion 41 provided in the recording data generating portion 42.

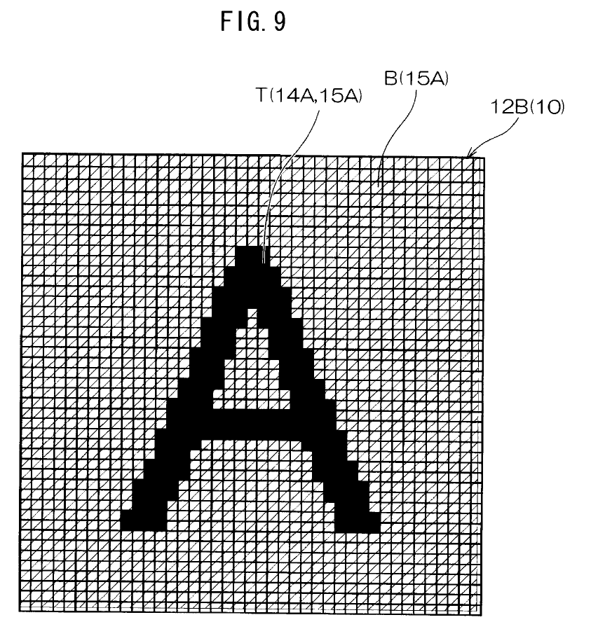

Consequently, to respective areas corresponding to respective pixels of respective image area T formed by the ejection of the ink droplets 14A and non-image area B on the curable solution layer 12B formed on the intermediate transfer belt 10, the ink droplets 14A, or the ink droplets 14A and the second liquid 15A are ejected so that the total amount of the ejected ink droplets 14A and the ejected second liquid 15A becomes equal to the maximum ejection amount M of the ink in the image area T, as shown in FIG. 9.

The area on the curable solution layer 12B to which the ink droplets 14A and the second liquid 15A have been ejected is nipped by the pressure rolls 16A and 16B to apply pressure when it reaches the position where the transfer device 16 is provided by the turn of the intermediate transfer belt 10, as described above, and, then, to the position (peeling position) nipped by the support roll 10C and the support 22, the state, in which the curable solution layer 12B is contacted with both the intermediate transfer belt 10 and the recording medium P, is maintained. Then, by supplying a stimulus to the curable solution layer 12B in the state of contacting with both the intermediate transfer belt 10 and the recording medium P by the stimulus supply device 18 via the intermediate transfer belt 10, the curable solution layer 12B cures. Then, by the peeling of the curable solution layer 12B from the intermediate transfer belt 10 at the peeling position, a cured resin layer (image layer) on which the image area T is formed by the ink droplets 14A is formed on the recording medium P.

As described above, according to the recording apparatus 102 of the embodiment, the ejection amounts of the ink droplets 14A and the second liquid 15A on the curable solution layer 12B are adjusted so as to be the same between areas corresponding to respective pixels of an image being the object for formation. Consequently, the swelling degree of curable solution layer 12B caused by the liquid absorption of the image area T and the non-image area B on the curable solution layer 12B becomes uniform, to suppress the difference in the layer thickness between the image area T and the non-image area B in the curable solution layer 12B as compared with the case where no second liquid 15A is ejected to the non-image area B.

Accordingly, the adhesion between the curable solution layer 12B and the recording medium P when the curable solution layer 12B is transferred to the recording medium P by the pressure rolls 16A and 16B is improved.

In the recording apparatus 102 of the embodiment, the generation of the difference in the layer thickness between the image area T and the non-image area B on the curable solution layer 12B due to the difference in the amount of liquid absorption is suppressed by ejecting the second liquid 15B to both the image area T and the non-image area B. Accordingly, it becomes possible to reduce the pressure added by the pressure rolls 16A and 16B while maintaining the adhesion between the curable solution layer 12B and the recording medium P, as compared with the case where no second liquid 15A is ejected to the non-image area B. Consequently, the recording apparatus 102 of the embodiment realizes both the improvement in the adhesion between the recording medium P and the curable solution layer 12B, and the improvement in the suppression of image defect.

Further, the recording apparatus 102 of the embodiment ejects the second liquid 15A not only to the non-image area B but also to the image area T, to adjust the swelling degree of the non-image area B and the image area T of the curable solution layer 12B due to the liquid absorption thereof. Accordingly, it is considered that the variation (namely, irregularity) of the thickness in the whole image area T and non-image area B in the curable solution layer 12B is further suppressed as compared with the case where the second liquid 15A is ejected only to the non-image area B, to achieve further improvement of the adhesion between the recording medium P and the curable solution layer 12B.

### Third Embodiment

In the first embodiment, the case where the second liquid 15A is ejected to the whole of the non-image area B on the curable solution layer 12B, is described. In the present embodiment, a configuration, in which only areas along the outer border of the image area T in the non-image area B on the curable solution layer 12B are defined as a non-image area B′ being the object of ejecting the second liquid 15A and the second liquid 15A is ejected to the non-image area B′, is described.

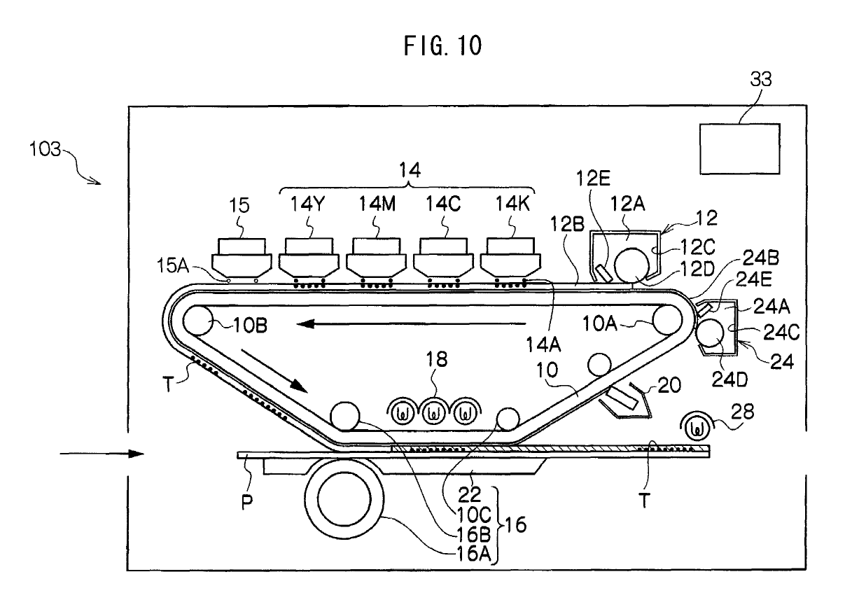

A recording apparatus 103 according to the third embodiment is provided, as shown in FIG. 10, with the intermediate transfer belt 10, the release agent applying device 24, the solution supply device 12 for supplying the curable solution 12A (detailed later) to form the curable solution layer 12B, the inkjet recording head 14 for forming dots by ejecting the ink droplets 14A in accordance with respective pixels of an image being the formation object to the curable solution layer 12B formed on the intermediate transfer belt 10 to form the image on the curable solution layer 12B, the second liquid ejection head 15 for ejecting the second liquid 15A onto the curable solution layer 12B, the transfer device 16, the stimulus supply device 18, the cleaning device 20, and a main controller 33.

The recording apparatus 103 of the embodiment has a constitution substantially similar to that of the recording apparatus 101 described in the first embodiment, except for being provided with the main controller 33 in place of the main controller 30. Therefore, portions having the same function are given the same symbol and detailed description is omitted.

The main controller 33 controls respective device portions provided in the recording apparatus 103, which is connected to respective device portions so as to be capable of sending/receiving signal, which is not shown.

The recording apparatus 103 corresponds to the recording apparatus of the invention, and the intermediate transfer belt 10 corresponds to the intermediate transfer member of the recording apparatus of the invention. Further, the solution supply device 12 corresponds to the supplying unit of the recording apparatus of the invention, and the inkjet recording head 14 is included in the first ejection unit of the recording apparatus of the invention. The second liquid ejection head 15 is included in the second ejection unit of the recording apparatus of the invention. The transfer device 16 corresponds to the transfer unit of the recording apparatus of the invention, and the stimulus supply device 18 corresponds to the stimulus supplying unit of the recording apparatus of the invention. Further, the main controller 33 corresponds to the control unit of the recording apparatus of the invention, and a calculation portion 46A, which will be described later, provided in the main controller 33 corresponds to the calculation unit of the recording apparatus of the invention.

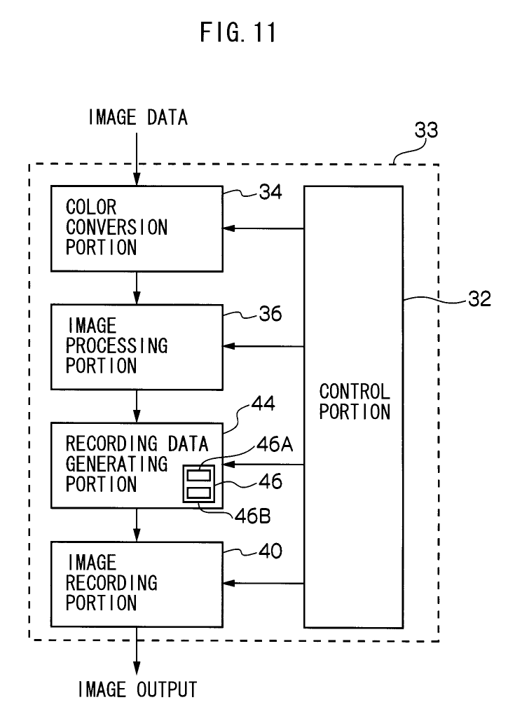

FIG. 11 is a schematic block diagram of the main controller 33. As shown in FIG. 11, the main controller 33 is constituted of at least the control portion 32, the color converting portion 34, the image processing portion 36, a recording data generating portion 44, and the image recording portion 40.

In the recording data generating portion 44, a second liquid data generating portion 46 is provided, in place of the second liquid data generating portion 39 described in the first embodiment. The second liquid data generating portion 46 is constituted of at least the calculation portion 46A and a memory 46B for storing various data.

It is intended that the main controller 33 obtains image data of an object to be recorded with the recording apparatus 103 from an external apparatus via a wireless line or a wire line via an input/output apparatus, which is not shown, provided in the recording apparatus 103. The image data are inputted to the color converting portion 34 described later. Further, in a similar manner to that in the first embodiment, it is intended that the image data inputted to the color converting portion 34 include data of respective pixels of the whole area of the recording medium P being the object for image formation. Namely, it is intended that the image data includes data of pixels corresponding to both the image area and the non-image area. It is intended that the data of respective pixels include information showing the position of respective pixels on the recording medium P (such as the position in row direction and the position in column direction) and the color of respective pixels (such as RGB data).

The control portion 32 generally controls the color converting portion 34, the image processing portion 36, the recording data generating portion 44, and the image recording portion 40. In the embodiment, the image recording portion 40 includes a component for recording an image in the recording apparatus 103 described with reference to FIG. 10.

The main controller 33 also has a constitution substantially similar to that described in the first embodiment, except that the second liquid data generating portion 46 is provided in place of the second liquid data generating portion 39. Therefore, the same portion is given the same symbol and detail description is omitted.

Also in the embodiment, the case where each of YMCK colors has two gradations, namely, the ink droplets ejected from respective nozzles of the inkjet recording heads 14 for respective colors (inkjet recording heads 14Y, 14M, 14C and 14K) have two gradations (namely, no ejection or ejection in anormal amount), is described as one example for simplifying the description, as is similar to the case for the first embodiment.

Further, in the embodiment, regarding the second liquid, too, a case, where the gradation number is five in accordance with the kinds of inks ejected from the inkjet recording head 14 as is similar to the case for the first embodiment, is described. Therefore, there are described five cases including the case where no second liquid is ejected from the second liquid ejection head 15; the case where the second liquid is ejected at the same amount (namely, normal amount) as the amount of ink ejected from one nozzle of the inkjet recording head 14 for one color among the inkjet recording heads 14 for respective colors at one time; the case where the liquid is ejected at two times as large as the normal amount (amount for two colors); the case where the liquid is ejected at three times as large as the normal amount (amount for three colors); and the case where the liquid is ejected at four times as large as the normal amount (amount for four colors).

The recording data generating portion 44 converts the image data having been binarized for respective YMCK colors of respective pixels in the image processing portion 36 to a data construction that can be decoded by the image recording portion 40, and rearranges data in a recording order (transfer order) to output the resulting data to the image recording portion 40. In this process, the recording data generating portion 44 generates the recording data considering ejection timing and data arrangement associated with the arrangement of inkjet recording heads and nozzles.

Further, the recording data generating portion 44 according to the embodiment generates not only data for the ejection of inks of YMCK four colors, but also data of the second liquid for the ejection of the second liquid 15A to the non-image area B′, while defining an area along the outer border of the image area T formed by dots recorded by ejecting the ink droplets 14A on the curable solution layer 12B on the basis of respective pixel values of image date of the formation object as the non-image area B′ being the only object for ejecting the second liquid 15A.

The data of the second liquid are generated by the second liquid data generating portion 46 provided in the recording data generating portion 44 (details are described later).

The image recording portion 40 allows nozzles of inkjet recording heads 14 for respective colors to eject the ink droplets 14A according to the recording data of YMCK generated in the recording data generating portion 44, as well as it allows the nozzle of the second liquid ejection head 15 to eject the second liquid 15A according to the data of the second liquid generated in the second liquid data generating portion 46 provided in the recording data generating portion 44.

As a result, the ink droplets 14A is ejected onto the curable solution layer 12B to form dots in accordance with pixels of an image being the formation object on the curable solution layer 12B to form the image area T, as well as the second liquid 15A is ejected to the non-image area B′, while defining the area along the outer border of the image area T as the non-image area B′ being the only object for ejecting the second liquid 15A.

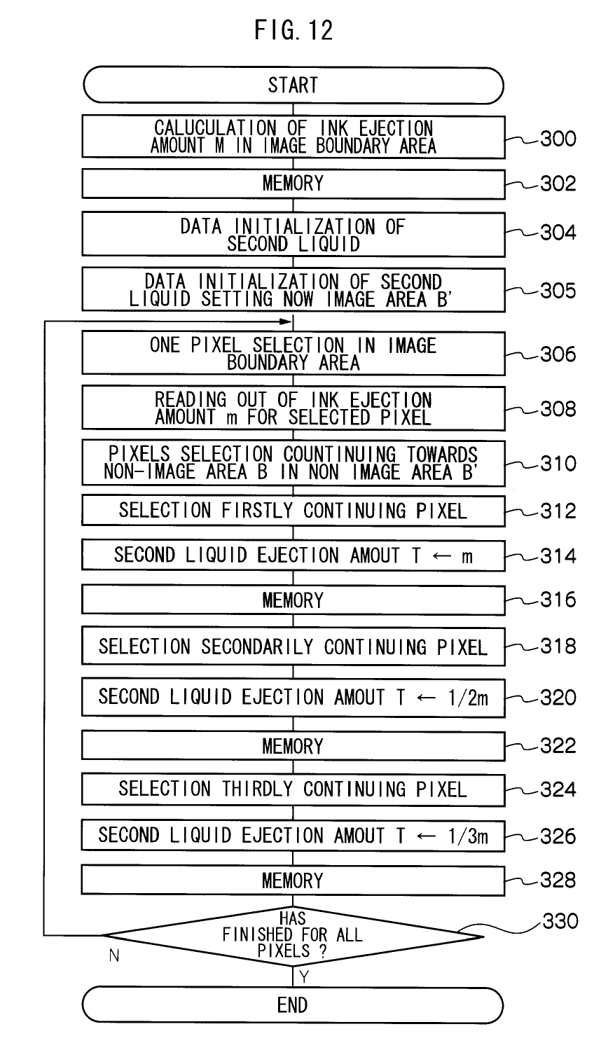

Next, as the action of the embodiment, the generation of data of the second liquid executed in the second liquid data generating portion 46 is explained using FIG. 12.

Firstly, at a step 300, the total amount m of ejection amount of the ink droplets 14A ejected for recording respective dots for each of pixels corresponding to respective dots constituting the border of the image area T among respective dots constituting the image area T formed on the curable solution layer 12B is calculated on the basis of the image data binarized for respective YMCK colors of respective pixels in the image processing portion 36.

In the embodiment, binarization (no ejection, or ejection in anormal amount) is performed for each of YMCK colors of respective pixels in the image processing portion 36. Accordingly, for example, in the case where respective dots constituting the border of the image area T among dots constituting the image area T formed on the curable solution layer 12B are dots formed by the ejection of the ink droplets 14A of two colors among YMCK four colors in the normal amount, respectively, when designating the normal amount as 100%, the ejection amount of 200% being two times thereof (two times as large as the normal amount (amount for two colors)) are calculated as the ejection amount m of the ink droplets 14A ejected for recording corresponding dots.

At a subsequent step 302, information showing the ejection amount m of the ink droplets 14A ejected for recording respective dots constituting the border of the image area T calculated by the processing at the step 300 and data showing the corresponding pixels are associated and stored in the memory 46B.

At a subsequent step 304, the data of the second liquid stored in the memory 46B is initialized. The data of the second liquid is data defining the amount of the second liquid for respective areas in accordance with respective pixels in the area corresponding to the recording medium P being the formation object on the curable solution layer 12B formed on the intermediate transfer belt 10.

The image data includes data of pixels corresponding to both the image area and the non-image area, because it is constituted of data showing respective pixels in the whole area corresponding to the recording medium P being the object for image formation.

In the embodiment, as for the amount of the second liquid, it is intended that four types, namely, three times as large as the normal amount, two times as large as the normal amount, the normal amount, and nothing, are set which are represented by “3,” “2,” “1” and “0”, respectively.

At the step 304, all the data of second liquid for each of dots in accordance with respective pixels in the area corresponding to the recording medium P on the curable solution layer 12B are set “0” to perform the initialization. As a result, for respective dots of respective pixels in all the area corresponding to the recording medium P being the object for image formation, the ejection of the second liquid is set null in the recording apparatus 103.

At a step 305, an area along the border of the image area T in the non-image area B on the curable solution layer 12B is set as the non-image area B′ being the object for ejecting the second liquid 15A, on the basis of image data binarized for respective YMCK colors of respective pixels in the image processing portion 36.

The processing at the step 305 sets, for example, for respective pixels constituting the area corresponding to the border (peripheral border) of the image area T on the curable solution layer 12B, an area constituted of the group of three pixels continuing from the respective pixels to the non-image area B side as the non-image area B′, on the basis of the image data.

The processing at the step 305 sets the area along the outer border of the image area T in the non-image area B other than the image area T on the curable solution layer 12B as the non-image area B′ being the object for ejecting the second liquid 15A. In the embodiment, a case, where the area of three pixels towards the outer border of the image area T in the non-image area B is set as the non-image area B′ being the object for ejecting the second liquid 15A, is described for simplifying the description. But, the area is not limited to three pixels.

At a subsequent step 306, among plural pixels constituting the border (peripheral border) of the image area T for which the ejection amount m of the ink droplets 14A is calculated in the step 300, one pixel that is not selected for calculating the ejection amount of the second liquid 15A is selected.

The selection at the step 306 is possible, for example, by selecting one pixel (such as a pixel at an i row and a j column of image data) for which the ejection amount of the second liquid 15A is not set yet among pixels continuing towards the non-image area B′ side among plural pixels constituting the border (peripheral border) of the image area T for which the ejection amount m of the ink droplets 14A is calculated at the step 300.

At a subsequent step 308, the ink ejection amount m for recording the dot corresponding to the pixel selected at the step 306 is read out from the memory 46B. The processing at the step 308 is possible by reading out the ink ejection amount m stored in accordance with the data showing the pixel selected at the step 306, which is stored in the memory 46B by the processing at the step 300.

At a subsequent step 310, pixels continuing from the pixel selected at the step 306 towards the non-image area B′ side in the non-image area B′ set at the step 305 are read out. In the embodiment, a case, in which three pixels continuing from the selected pixel towards the non-image area B′ side are read out as the continuing pixels, is described.

In the embodiment, the case, in which three pixels are read out, is described. But, it is sufficient that the number of the pixels is at least one, and it may also be one, two, or four. In this case, it is sufficient to determine, at the step 305, areas of one pixel, two pixels or four pixels, respectively, that are continuing from the image area T towards the non-image area B side as the respective non-image area B′.

At a subsequent step 312, a pixel firstly continuing (namely, adjacent) to the pixel selected at the step 306 among three pixels selected at the step 310 is selected.

At a subsequent step 314, the ink ejection amount m read out at the step 308 is set as the ejection amount T of the second liquid 15A to the pixel selected at the step 312.

At a subsequent step 316, the ink ejection amount m having been set and data showing the pixel selected at the step 312 are associated and stored in the memory 46B.

At a subsequent step 318, a pixel secondarily continuing to the pixel selected at the step 306 is selected among the three pixel selected at the step 310.

At a subsequent step 320, m/2 being the amount of one half of the ink ejection amount m read out at the step 308 is set as the ejection amount T of the second liquid 15A to the pixel selected at the step 318.

At a subsequent step 322, the ink ejection amount m/2 having been set and the data showing the pixel selected at the step 318 are associated and stored in the memory 46B.

At a subsequent step 324, a pixel thirdly continuing to the pixel selected at the step 306 is selected among the three pixels selected at the step 310 is selected. At a subsequent step 326, m/3 being an amount of one third of the ink ejection amount m read out at the step 308 is set as the ejection amount T of the second liquid 15A to the pixel selected at the step 324.

At a subsequent step 328, the ink ejection amount m/3 having been set and data showing the pixel selected at the step 318 are associated and stored in the memory 46B.

At a subsequent step 330, whether or not the setting of the ejection amount T of the second liquid 15A has terminated is estimated for the whole pixels of the non-image area B′ set at the step 305. When affirmed, the routine terminates, and when denied, it returns to the step 306.

By executing the processing at the steps 300-330 in the second liquid data generating portion 46, data of the second liquid are generated.

The data of the second liquid are generated through the processing at the steps 300-330, and, consequently, the amount of the second liquid 15A ejected to the image area B′ at the outer border of the image area T on the curable solution layer 12B is set so that the ejection amount is reduced step-by-step from the border of the image area T towards the non-image area B side.

In the image recording portion 40, dots in accordance with the pixels of an image being the formation object are formed on the curable solution layer 12B by ejecting the ink droplets 14A from nozzles of the inkjet recording heads 14 for respective colors according to the recording date of YMCK generated in the recording data generating portion 44 to form the image area T.

Further, in the image recording portion 40, the second liquid 15A is ejected to the non-image area B′ being an area along the outer border of the image area T on the curable solution layer 12B so that the ejection amount is reduced step-by-step from the image area T towards the non-image area B, by ejecting the second liquid 15A from the nozzle of the second liquid ejection head 15 according to the data of the second liquid generated in the second liquid data generating portion 46.

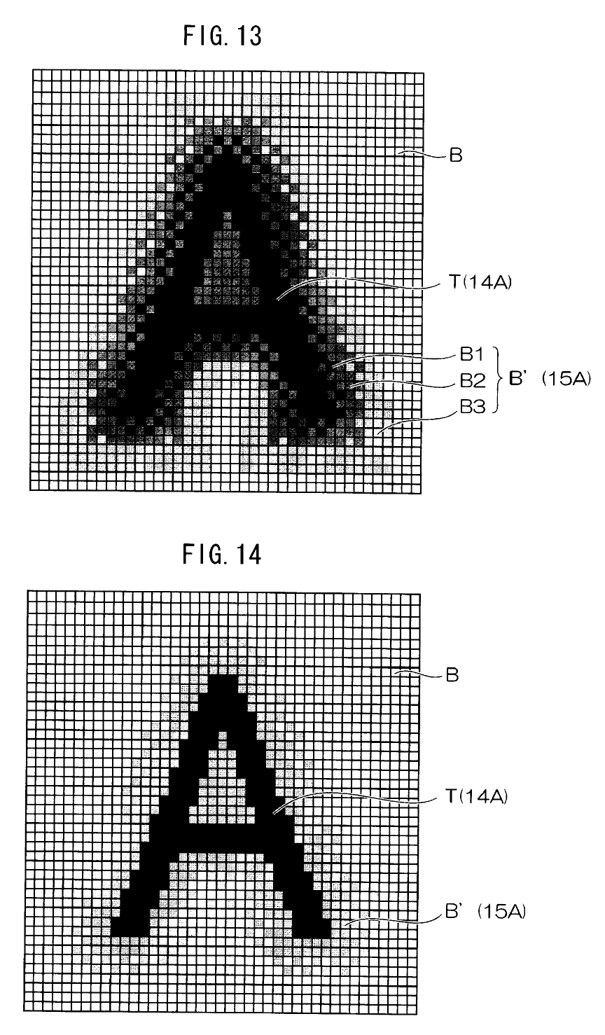

For this purpose, for example, as shown in FIG. 13, the second liquid 15A is ejected in the image area B′ at the outer border of the image area T on the curable solution layer 12B so that the ejection amount is reduced step-by-step from the border of the image area T towards the non-image area B side. For example, as shown in FIG. 13, to a non-image area B1 being an area adjacent to the outside of the image area T on the curable solution layer 12B, the second liquid 15A is ejected in the same amount as the amount of the ink droplets 14A ejected for recording dots constituting the border portion of the image area T. Then, to a non-image area B2 being an area that is adjacent to the non-image area B1 on the further non-image area B side, the second liquid 15A is ejected in an amount of one half of the amount of the ink droplets 14A ejected for recording dots constituting the border portion of the image area T. To an non-image area B3 lying further outside, the second liquid 15A is ejected in an amount of one third of the amount of the ink droplets 14A.

Consequently, to the non-image area B′ along the outside of the image area T in the non-image area B other than the image area T on the curable solution layer 12B, less amount of second liquid 15A is ejected as the distance from the position near the image area T increases.

The area to which the ink droplets 14A and the second liquid 15A have been ejected on the curable solution layer 12B is nipped by the pressure rolls 16A and 16B to apply pressure when it reaches the position provided with the transfer device 16 through the turn of the intermediate transfer belt 10, as described above, and, after that, to the position (peeling position) nipped by the support roll 10C and the support 22, the state, in which the curable solution layer 12B contacts with both the intermediate transfer belt 10 and the recording medium P, is maintained. Then, by supplying a stimulus to the curable solution layer 12B in the state of contacting with both the intermediate transfer belt 10 and the recording medium P via the intermediate transfer belt 10 by the stimulus supply device 18, the curable solution layer 12B cures. Then, the curable solution layer 12B is peeled from the intermediate transfer belt 10 at the peeling position to form a cured resin layer (image layer), on which the image area T by the ink droplets 14A is formed, on the recording medium P.

As described above, according to the recording apparatus 103 of the embodiment, to the non-image area B′ along the outside of the image area T in the non-image area B other than the image area T on the curable solution layer 12B, the second liquid 15A is ejected in a less amount as the distance from the position near the image area T increases. Consequently, the second liquid 15A is ejected so that the amount thereof is decreased step-by-step from the boundary between the image area T and the non-image area B other than the image area T to the non-image area B on the curable solution layer 12B. Therefore, the difference in the layer thickness at the boundary between the image area T and the non-image area B in the curable solution layer 12B is suppressed.

Accordingly, the adhesion between the curable solution layer 12B and the recording medium P when the curable solution layer 12B is transferred to the recording medium P by the pressure rolls 16A and 16B is improved.

Further, since the recording apparatus 103 of the embodiment ejects the second liquid 15A so that the amount thereof decreases step-by-step from the boundary between the image area T and the non-image area B towards the non-image area B to suppress the difference in the layer thickness between the image area T and the non-image area B in the curable solution layer 12B, it becomes possible to reduce the pressure added by the pressure rolls 16A and 16B as compared with the case where no second liquid 15A is ejected to the non-image area B, while maintaining the adhesion between the curable solution layer 12B and the recording medium P. This realizes, in the recording apparatus 103 of the embodiment, both the improvement in the adhesion between the recording medium P and the curable solution layer 12B, and the improvement in the suppression of image defect.

Further, the recording apparatus 103 of the embodiment is particularly effective for a case where the area occupied by the image area T is smaller compared with the area occupied by the non-image area B, for example, the image area T is a text area constituted of one or plural characters, and suppresses the ejection amount of the second liquid 15A.

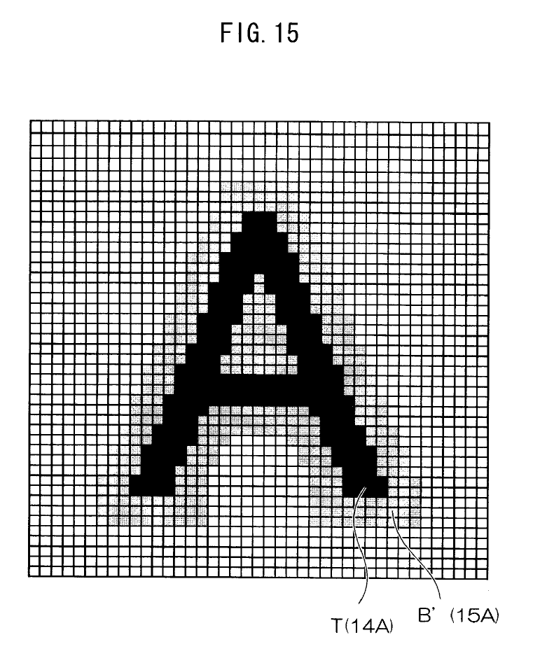

In the recording apparatus 103 of the embodiment, a case, where the ejection amount of the second liquid 15A decreases step-by-step from the boundary between the image area T and the non-image area B′ towards the non-image area B, is described. However, such form may also be adopted that the same amount of the second liquid 15A as the ejection amount m of the ink droplets 14A ejected for recording dots corresponding to pixels constituting the outer border of the image area T is ejected into the non-image area B′ along the image area T (see FIG. 15).

In the recording apparatus 103 of the embodiment, the case where the ejection amount of the second liquid 15A decreases step-by-step from the boundary between the image area T and the non-image area B′ towards the non-image area B, is described. Further, such form may also be adopted that a constant ejection amount of the second liquid 15A is ejected so as to reduce the coverage (dot area percent) of the second liquid 15A from the boundary towards the non-image area B (see FIG. 14).

Further, in the recording apparatus 103 of the embodiment, a case, where the ejection amount of the second liquid 15A decreases step-by-step at such ratio as one, one half and one third from the boundary between the image area T and the non-image area B′ towards the non-image area B, is described. However, it is sufficient that the ejection amount of the second liquid 15A decreases as the distance from the boundary between the image area T and the non-image area B′ increases. No limitation is imposed on the ratio.

### EXAMPLES

Hereinafter, the present invention is described more specifically by reference to Examples. But, these respective Examples do not limit the invention.

### Example 1

Using a recording apparatus having a constitution substantially similar to that in the first embodiment (refer to FIG. 1), a curable solution is supplied to an intermediate transfer belt by a solution supply device to form a curable solution layer. To the curable solution layer, inks of respective colors are ejected by inkjet recording heads to form an image area on the curable solution layer. In addition, to a non-image area other than the image area on the curable solution layer, a second liquid is ejected.

The image area is formed by ejecting ink droplets in an amount corresponding to two colors for respective dots, that is, ejecting ink droplets in an amount of 2 pL×2=4 pL.

Further, to the non-image area, 2 pL of the second liquid are ejected to areas corresponding to respective pixels. The data of the second liquid for ejecting the second liquid to the non-image area is generated by executing the processing routine shown in FIG. 3 in the second liquid data generating portion. Further, the maximum ejection amount M of the ink in FIG. 3 is set 4 pL as described above, and X being the ejection amount of the second liquid that is ejected to areas corresponding to respective pixels of the non-image area at the step 118 is set 2 pL.

And, the curable solution layer, to which the ink droplets and the second liquid are ejected, is contacted with the recording medium by a transfer device, to which a stimulus is supplied by a stimulus supplying unit to cure the curable solution layer. The cured layer is peeled off from the intermediate transfer belt to be evaluated. Conditions are as follows. In the following, an ultraviolet irradiation intensity and an accumulated light amount are the ultraviolet irradiation intensity and the accumulated light amount after passing through the intermediate transfer belt.
Intermediate transfer belt: endless belt having a thickness of 0.1 nm, a belt width of 350 mm, and an outer diameter Φ of 168 mm, made of ETFE (process speed: 400 mm/s)
Solution supply device: gravure roll coater (thickness of the curable solution layer: 15 μm)
Respective inkjet recording heads: inkjet recording head of a piezoelectric system (resolution 1200×1200 dpi (dpi: number of dots per one inch, hereinafter the same), drop size 2 pL)
Second liquid ejection head: inkjet recording head of a piezoelectric system (resolution 1200×1200 dpi, drop size 2 pL)
Transfer device (pressure roll): roll formed by covering a steel pipe having a diameter of 30 mm with silicone rubber (pressing pressure against the intermediate transfer belt: 5 kPa)
Stimulus supply device: metal halide lamp (which irradiates ultraviolet rays of 100 mJ/cm² in an accumulated light amount at an irradiation intensity of 240 W/cm)
Recording medium: art paper (Tradename: OK Kinfuji, manufactured by Oji Paper Co., Ltd.)

As the curable solution, inks of respective colors and the second liquid, ones prepared in the following manner are used.

Curable Solution (Radical Curable Resin)
Polyrurethane acrylate: 40 parts by weight
Acryloyl morpholine (UV curable monomer): 20.0 parts by weight
Sodium polyacrylate (liquid absorbing resin, having a number average particle diameter of 2.5 μm prepared by ball mill pulverization): 35.0 parts by weight.
Methylbenzoyl benzoate (photopolymerization initiator): 5 parts by weight

Black Ink

CAB-O-JET-300 (manufactured by Cabot Corp.) is treated with an ultrasonic homogenizer for 30 minutes, which is then subjected to a centrifugation treatment (at 7000 rpm for 20 minutes) to obtain a pigment dispersion (carbon concentration: 12.8%).

Next, respective components below are mixed sufficiently, and the resulting mixture is subjected to pressure filtration with a 1 μm filter to prepare an ink.
Above pigment dispersion: 40 parts by weight
Glycerin: 20 parts by weight
Surfactant (SURFYNOL 465: manufactured by Nisshin Chemical Industry Co., Ltd.): 1.5 parts by weight
Pure water: 35 parts by weight

Ink Production Method 1

To 30 parts by weight of the pigment, 3 parts by weight of a sodium neutralized salt of styrene-maleic acid copolymer are added, and ion-exchange water is further added to give the total amount of 300 parts by weight. The resulting liquid is dispersed using an ultrasonic homogenizer. The obtained liquid is centrifuged with a centrifugal separator, from which 100 parts by weight of the remnant are removed. The supernatant is passed through a 1 μm filter to give a dispersion. To an appropriate amount of the dispersion, 10 parts by weight of glycerin, 5 parts by weight of diethylene glycol monobutyl ether, 0.03 parts by weight of surfactant, 3 parts by weight of isopropyl alcohol, and an appropriate amount of ion-exchange water and sodium hydroxide are added so as to give the total amount of 100 parts by weight and the pigment concentration of 5% by weight. The resultant mixture is mixed well and passed through a 1 μm filter to give an intended ink.

Cyan Ink

According to the above ink production method 1, an ink having a composition shown below is obtained.
C. I. Acid Blue 199: 5 parts by weight
Styrene-maleic acid-sodium maleate copolymer: 0.3 parts by weight
Glycerin: 15 parts by weight
Diethylene glycol monobutyl ether: 5 parts by weight
Surfactant (SURFINOL 465: manufactured by Nissin Chemical Industry Co., Ltd.): 1.0 part by weight
Isopropyl alcohol: 3 parts by weight
Ion-exchange water: remainder
   Total: 100 parts by weight

Magenta Ink

According to the above ink production method 1, an ink having a composition shown below is obtained.
C. I. Acid Red 52: 3.5 parts by weight
Styrene-maleic acid-sodium maleate copolymer: 0.3 parts by weight
Glycerin: 15 parts by weight
Diethylene glycol monobutyl ether: 5 parts by weight
Surfactant (SURFYNOL 465: manufactured by Nissin Chemical Industry Co., Ltd.): 1.0 part by weight
Ion-exchange water: remainder
   Total: 100 parts by weight

Yellow Ink

According to the above ink production method 1, an ink having a composition shown below is obtained.
C. I. Direct Yellow 86: 4.0 parts by weight
Styrene-maleic acid-sodium maleate copolymer: 0.4 parts by weight
Glycerin: 15 parts by weight
Diethylene glycol monobutyl ether: 10 parts by weight
Surfactant (SURFYNOL 465: manufactured by Nissin Chemical Industry Co., Ltd.): 1.0 part by weight
Ion-exchange water: remainder
   Total 100 parts by weight

Production Method of Second Liquid

A second liquid having a composition shown below is obtained in a manner substantially similar to that in the ink production method 1, except for using no pigment.
Styrene-maleic acid-sodium maleate copolymer: 0.3 parts by weight
Glycerin: 20 parts by weight
Diethylene glycol monobutyl ether: 5 parts by weight
Surfactant (SURFYNOL 465: manufactured by Nissin Chemical Industry Co., Ltd.): 1.0 part by weight
Isopropyl alcohol: 3 parts by weight
Ion-exchange water: remainder
   Total 100 parts by weight

<Evaluation>

Onto the curable solution layer having a thickness of 15 μm formed by the solution supply device, each of 4 pL ink droplets (above-described magenta, yellow and cyan inks) is ejected while changing a position for each ejection, respectively. Then, arbitrary 20 points are selected among plural dots formed on the curable solution layer 12B and the maximum value of the height of the convex portions formed on the curable solution layer by the ejection of a 4 pL ink droplet is measured to give 9 μm.

The height of the convex portion is obtained by measuring the profile of an image area and a non-image area on the surface of the curable solution layer with a laser three dimensional shape measurement apparatus (VK-8700, manufactured by KEYENCE CORPORATION).

Further, in a similar manner, onto the curable solution layer having a thickness of 15 μm formed by the solution supply device on the intermediate transfer member, a 2 pL second liquid is ejected while changing a position for each ejection, respectively. Then, arbitrary 20 points in plural areas where the second liquid is ejected on the curable solution layer are selected and the maximum value of the height of the convex portions formed on the curable solution layer by the ejection of a 2 pL second liquid is measured to give 4.5 μm. The height of the convex portion is measured using a similar method to that used for measuring the height of the convex portion caused by the ink drop.

It is revealed that, when the ink droplet and the second liquid are ejected onto the curable solution layer under the above conditions in the recording apparatus, the difference in the layer thickness between the image area formed by the ejection of the ink droplet and the non-image area onto which the second liquid is ejected on the curable solution layer is 4.5 μm. Here, when no second liquid is ejected onto the curable solution layer, the difference in the thickness between the image area formed by the ejection of the ink droplets and the non-image area onto which no second liquid is ejected is 9.0 μm.

Therefore, it is revealed that the difference in the thickness between the image area and non-image area on the curable solution layer is suppressed.

<Evaluation of Adhesion between Curable Solution Layer and Recording Medium>

Using art paper (OK Kinfuji, manufactured by Oji Paper Co., Ltd.) as a recording medium, a continuous 5-sheet print test is preformed. The boundary portion between the image portion and the non-image portion of the transferred curable solution layer on the art paper after the test is observed under magnification, and the adhesion is evaluated on the basis of whether or not the boundary portion lifts (whether or not air remains). A case, where the lift at the boundary portion is less than 10% of the total length of the observed boundary portion, is determined to be good in adhesion, and, a case, where it is 10% or more, is determined to be poor in adhesion.

In Example 1, as a result, the lift at the boundary portion between the image area and the non-image area on the art paper is less than 3%, and good adhesion is obtained.

<Evaluation of Image Defect>

### Image Defect Evaluation

On the curable solution layer formed on the intermediate transfer belt, dots corresponding to pixels constituting characters from 2 points to 10 points are formed in a similar manner to that described above to define the image area, and, onto the non-image area other than the image area, the second liquid is ejected.

Regarding the image area, 2 pL of magenta ink and 2 pL of cyan ink are ejected to form dots corresponding to respective pixels, thereby forming a 4 pL ink image. Regarding the non-image area, to areas corresponding to respective pixels of the non-image area, 2 pL of the second liquid are ejected.

The curable solution layer onto which the ink droplets and the second liquid are ejected is transferred to the recording medium by the transfer device. The pressing pressure with respect to the intermediate transfer belt in the transfer device (pressure roll) is, as described above, 5 kPa. And, for the above-described image, a print test of continuously printing the image on the recording medium up to 100 sheets is performed. The 100th printed image is evaluated.

Evaluation Standard

The evaluation is performed on the basis of the following evaluation standard.
G1: No thickening is observed, even local thickening is not observed, and all the characters are sharp.
G2: Partial thickening is observed in the line image, and a deformed character is observed.
G3: Thickening of the line image is observed in almost all the area, and deformation is also observed for almost all the characters.

In Example 1, the result of G1 is obtained for all the character images.

Therefore, it is revealed that Example 1 realizes both good adhesion with respect to the recording medium and the inhibition of image defect.

### Example 2

Using a recording apparatus having a constitution substantially similar to that in the second embodiment (refer to FIG. 6), a curable solution is supplied to an intermediate transfer belt by a solution supply device to form a curable solution layer. To the curable solution layer, inks of respective colors are ejected by inkjet recording heads to form an image area on the curable solution layer. In addition, to both the image area and a non-image area other than the image area on the curable solution layer, a second liquid is ejected.

The image area is formed so as to have an area in which ink droplets of 2 pL×2=4 pL are ejected for respective dots by ejecting the ink droplets corresponding to two colors for respective dots, and to have an area in which ink droplets of 2 pL are ejected for respective dots by ejecting the ink droplets corresponding to one color.

Then, to the area to which ink droplets of 2 pL have been ejected in the image area, 2 pL of the second liquid are ejected, and, to the non-image area, 4 pL of the second liquid are ejected. Data of the second liquid for ejecting the second liquid to the non-image area are generated by executing the processing routine shown in FIG. 8 in the second liquid data generating portion. In FIG. 8, the maximum ejection amount M of the ink is 4 pL as described above, and, S at the step 222 is 4 pL for pixels in which ink droplets of 4 pL are ejected for respective dots in the image area, and 2 pL for pixels in which ink droplets of 2 pL are ejected for dots in the image area. Further, S is 0 pL for respective pixels in the non-image area.

And, the curable solution layer, to which the ink droplets is ejected in the image area and the second liquid is ejected in both the image area and the non-image area, is contacted with the recording medium by a transfer device, to which a stimulus is supplied by the stimulus supplying unit to cure the curable solution layer. Then, the cured layer is peeled off from the intermediate transfer belt to be evaluated in a similar manner to that in Example 1. Conditions substantially similar to those in Example 1 are adopted in the Example 2, except for adopting 2 kPa as the pressing pressure for the intermediate transfer belt in the transfer device (pressure roll).

<Evaluation>

Onto the curable solution layer having a thickness of 15 μm formed by the solution supply device, each of 4 pL ink droplets (above-described magenta, yellow and cyan inks) is ejected while changing a position for each ejection, respectively. Then, arbitrary 20 points are selected among plural dots formed on the curable solution layer 12B and the maximum value of the height of the convex portions formed on the curable solution layer by the ejection of a 4 pL ink droplet is measured in a similar manner to that in Example 1 to give 9 μm.

Further, in a similar manner, onto the curable solution layer having a thickness of 15 μm formed by the solution supply device on the intermediate transfer member, a 4 pL second liquid is ejected while changing a position for each ejection, respectively. Then, arbitrary 20 points in plural areas where the second liquid is ejected on the curable solution layer are selected and the maximum value of the height of the convex portions formed on the curable solution layer by the ejection of a 4 pL second liquid is measured to give 9 μm. The height of the convex portion is measured using a similar method to that used for measuring the height of the convex portion formed by the ink droplet.

Further, onto the curable solution layer having a thickness of 15 μm formed by the solution supply device, each of 2 pL ink droplets (above-described magenta, yellow and cyan inks) is ejected while changing a position for each ejection, respectively, and then a 2 pL second liquid is respectively ejected to respective positions corresponding to respective dots. Then, arbitrary 20 points are selected among plural dots formed on the curable solution layer 12B and the maximum value of the height of the convex portions formed on the curable solution layer by the ejection of a 2 pL ink droplet and 2 pL second liquid is measured to give 9 μm.

It is revealed that, when the ink droplet and the second liquid are ejected onto the curable solution layer under the above conditions in the recording apparatus, the layer thickness in the whole area of the image areas formed by the ejection of ink droplets on the curable solution layer is uniform, as well as the difference in the layer thickness between the image area and the non-image area on the curable solution layer is suppressed.

Therefore, it is revealed that the difference in the thickness in the image area, and the difference in the thickness between the image area and non-image area on the curable solution layer are suppressed.

<Evaluation of Adhesion between Curable Solution Layer and Recording Medium>

The adhesion is evaluated by a similar evaluation method to that in Example 1, and as a result, the lift at the boundary portion between the image area and the non-image area on art paper is less than 1%, to give a good adhesion.

<Evaluation of Image Defect>

The image defect is evaluated by an evaluation method substantially similar to that in Example 1, except for changing the ejection amounts of the ink droplet and the second liquid.

Specifically, in Example 2, for the image area, dots recorded by the 4 pL ink droplet by ejecting the 2 pL magenta ink and the 2 pL cyan ink and dots recorded by only the 2 pL ink droplet by ejecting the 2 pL magenta ink alone are allowed to coexist for forming dots corresponding to respective pixels. Further, to each of the area of dots recorded by the ejection of a 2 pL ink droplet in the image area, an additional 2 pL second liquid is ejected. For the non-image area, a 4 pL second liquid is ejected to areas corresponding to respective pixels on the non-image area.

The curable solution layer onto which the ink droplets and the second liquid are ejected is transferred to the recording medium by the transfer device. The pressing pressure relative to the intermediate transfer belt in the transfer device (pressure roll) is set 2 kPa.

And, for the above-described image, a print test of continuously printing the image on the recording medium up to 100 sheets is performed. The 100th printed image is evaluated.

Also in Example 2, the result of G1 is obtained for all the character images.

Therefore, it is revealed that Example 2 also realizes both good adhesion with respect to the recording medium and the inhibition of image defect.

### Example 3

Using a recording apparatus having a constitution substantially similar to that in the third embodiment (refer to FIG. 10), the curable solution is supplied to the intermediate transfer belt by the solution supply device to form the curable solution layer. To the curable solution layer, inks of respective colors are ejected by the inkjet recording heads to form an image area on the curable solution layer. In addition, to both the image area and the non-image area other than the image area on the curable solution layer, the second liquid is ejected.

For the image area, an ink droplet corresponding to two colors is ejected to eject an ink droplet of 2 pL×2=4 pL for respective dots.

In Example 3, as the non-image area being the ejection object of the second liquid, an area corresponding to three pixels along the outer border of the image area is determined. Then, the second liquid is ejected so that the ejection amount decreases in the order of 4 pL, 2 pL and 0 pL as the distance from the boundary between the image area and the non-image area increases. Data of second liquid for ejecting the second liquid to the non-image area are generated by executing the processing routine shown in FIG. 12 in the second liquid data generating portion. In FIG. 12, the ink ejection amount m of the edge portion of the image in the image area is 4 pL as described above, the ejection amount T of the second liquid set at the step 314 is 4 pL, the ejection amount T of the second liquid set at the step 320 is 2 pL, and the ejection amount of the second liquid set at the step 326 is 0 pL.

And, the curable solution layer, to which the ink droplets are ejected in the image area and the second liquid is ejected in both the image area and the non-image area, is contacted with the recording medium by the transfer device, to which a stimulus is supplied by the stimulus supplying unit to cure the curable solution layer. The cured layer is peeled off from the intermediate transfer belt to be evaluated in a similar manner to that in Example 1. The conditions substantially similar to those in Example 1 are adopted in the Example 3, except for adopting 5 kPa as the pressing pressure for the intermediate transfer belt in the transfer device (pressure roll).

<Evaluation>

Onto the curable solution layer having a thickness of 15 μm formed by the solution supplying device, each of 4 pL ink droplets (above-described magenta, yellow and cyan inks) is ejected while changing a position for each ejection, respectively. Then, arbitrary 20 points are selected among plural dots formed on the curable solution layer 12B and the maximum value of the height of the convex portions formed on the curable solution layer by the ejection of a 4 pL ink droplet is measured to give 9 μm.

Further, in a similar manner, onto the curable solution layer having a thickness of 15 μm formed by the solution supply device on the intermediate transfer member, a 4 pL second liquid is ejected while changing a position for each ejection, respectively. Then, arbitrary 20 points in plural areas where the second liquid is ejected on the curable solution layer are selected and the maximum value of the height of the convex portions formed on the curable solution layer by the ejection of a 4 pL second liquid is measured to give 9 μm. The height of the convex portion is measured using a similar method to that used for measuring the height of the convex portion formed by the ink drop.

Further, onto the curable solution layer having a thickness of 15 μm formed by the solution supply device, each of 2 pL of ink droplets (above-described magenta, yellow and cyan inks) is ejected while changing a position for each ejection, respectively. Then, arbitrary 20 points are selected among plural dots formed on the curable solution layer 12B and the maximum value of the height of the convex portions formed on the curable solution layer by the ejection of a 2 pL second liquid is measured to give 4.5 μm.

It is revealed that, when the ink droplets and the second liquid are ejected onto the curable solution layer under the above conditions in the recording apparatus, the height of the convex portion formed by the ejection of the ink droplets or the second liquid decreases step-by-step in the order of 9 μm, 4.5 μm, and 0 μm as the distance from the edge portion of the image area formed by the ejection of the ink droplets on the curable solution layer increases. Consequently, it is revealed that the difference in the layer thickness at the boundary between the image area and the non-image area is suppressed.

Therefore, it is revealed that the difference in the thickness in the image area, and the difference in the thickness at the boundary between the image area and the non-image area on the curable solution layer are suppressed.

<Evaluation of Adhesion between Curable Solution Layer and Recording Medium>

The adhesion is evaluated by a similar evaluation method to that in Example 1, and as a result, the lift at the boundary portion between the image area and the non-image area on art paper is less than 3%, to give a good adhesion.

<Evaluation of Image Defect>

The image defect is evaluated by an evaluation method substantially similar to that in Example 1, except for changing the ejection amounts of the ink droplets and the second liquid.

Specifically, in Example 3, for the image area, a 4 pL ink droplet ejection is carried out by ejecting 2 pL of the magenta ink and 2 pL of the cyan ink in order to form dots corresponding to respective pixels. For the non-image area, the second liquid is ejected so that the ejection amount decreases step-by-step in the order of 4 pL, 2 pL and 0 pL as the distance from the boundary with the image area increases.

The curable solution layer onto which the ink droplets and the second liquid are ejected is transferred to the recording medium by the transfer device. The pressing pressure with respect to the intermediate transfer belt in the transfer device (pressure roll) is set 50 kPa/cm by line pressure.

And, for the above-described image, a print test of continuously printing the image on the recording medium up to 100 sheets is performed. The 100th printed image is evaluated.

Also in Example 3, the result of G1 is obtained for all the character images.

Therefore, it is revealed that Example 3 also realizes both good adhesion with respect to the recording medium and the inhibition of image defect.

### Comparative Example 1

Under conditions substantially similar to those in Example 1 except for ejecting no second liquid, the evaluation of the adhesion between the curable solution layer and the recording medium, and the evaluation of the image defect are performed.

The evaluation of the adhesion is performed by a similar evaluation method to that in Example 1, and as a result, the lift at the boundary portion between the image area and the non-image area on art paper is 50% or more to show that the adhesion lowers as compared with the results in Example 1.

Regarding the evaluation of the image defect, when the pressing pressure with respect to the intermediate transfer belt in the transfer device (pressure roll) is set 5 kPa, the evaluation result of the 100th printed image in the printing test is G2, that is, a partial thickening is observed in the line image and a deformed character is observed.

Then, the pressing pressure with respect to the intermediate transfer belt is set 20 kPa. Regarding the evaluation of the adhesion, a result that the lift at the boundary portion between the image area and the non-image area on the art paper is less than 8%, that is, a good evaluation result comparable to that in Example 1 is obtained. However, the evaluation of the image defect is G3, that is, thickening of the line image is observed in almost all areas and deformation is observed for almost all characters.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

All publications, patent applications, and technical standards mentioned in this specification are herein incorporated by reference to the same extent as if such individual publication, patent application, or technical standard was specifically and individually indicated to be incorporated by reference. It is intended that the scope of the invention be defined by the following claims and their equivalents.

What is claimed is:

1. A recording apparatus comprising:
an intermediate transfer member;
a supplying unit that supplies a curable solution containing a curable resin that cures by a stimulus from the outside, onto the intermediate transfer member;
a first ejection unit that ejects an ink to a curable solution layer formed on the intermediate transfer member;
a second ejection unit that ejects a second liquid to the curable solution layer;
a transferring unit that contacts the curable solution layer to which the ink and the second liquid have been ejected with a recording medium to transfer the curable solution layer from the intermediate transfer member to the recording medium;
a stimulus supplying unit that supplies a stimulus for curing the curable solution layer, to the curable solution layer; and
a control unit that controls an ejection of the ink with the first ejection unit to eject, on the basis of image data, the ink to record dots in accordance with respective pixels of an image of the image data, and controls an ejection of the second liquid with the second ejection unit to eject the second liquid on the curable solution layer.

2. The recording apparatus according to claim 1, further comprising a release agent supplying unit that supplies a release agent onto the intermediate transfer member.

3. The recording apparatus according to claim 1, wherein the stimulus is an ultraviolet ray, an electron beam or heat.

4. The recording apparatus according to claim 1, wherein the intermediate transfer member has a property of stimulus permeability that allows the stimulus to permeate.

5. The recording apparatus according to claim 1, further comprising a cleaning device for cleaning a residual material or an adhered material on the surface of the intermediate transfer member after transferring the curable solution layer from the intermediate transfer member to the recording medium.

6. The recording apparatus according to claim 1, further comprising a stimulus supply device for further curing the curable solution layer that has been transferred to the recording medium.

7. The recording apparatus according to claim 1, wherein the control unit
includes a calculation unit that calculates a maximum ejection amount of the ink for recording the dots in accordance with respective pixels of the image of the image data on the basis of the image data, and
controls the second ejection unit so as to eject the second liquid to areas corresponding to respective pixels of the non-image area in an amount being equal to or less than the maximum ejection amount.

8. The recording apparatus according to claim 1, wherein the second liquid is a pale colored solution.

9. The recording apparatus according to claim 8, wherein the control unit
includes a calculation unit that calculates the maximum ejection amount of the ink for recording the dots in accordance with respective pixels of the image of the image data on the basis of the image data,
determines the ejection amount of the second liquid to be ejected to areas corresponding to respective pixels of the image area for each pixel so that the summed amount of the ejection amount of the ink ejected for recording a dot in accordance with respective pixels of the image area and the ejection amount of the second liquid ejected to the area where the dot is recorded becomes equal to the maximum ejection amount,
controls the second ejection unit so as to eject the second liquid in the determined ejection amount to areas corresponding to respective pixels, and
controls the second ejection unit so as to eject the second liquid to areas corresponding to respective pixels of the non-image area in an amount being equal to or less than the maximum ejection amount.

10. The recording apparatus according to claim 1, wherein the control unit controls the second ejection unit so as to define an area along the outer border of the image area formed on the curable solution layer as the non-image area and to eject the second liquid to the non-image area.

11. The recording apparatus according to claim 10, wherein the control unit controls the second ejection unit so that the ejection amount of the second liquid decreases as the distance from the boundary between the image area and the non-image area increases for the area along the outer border of the image area defined as the non-image area.

12. The recording apparatus according to claim 11, wherein the control unit
includes a calculation unit that calculates a maximum ejection amount of the ink for recording a dot in accordance with respective pixels of the image of the image data on the basis of the image data, and
controls the second ejection unit so as to eject the second liquid to an area corresponding to a pixel continuous to the boundary between the image area and the non-image area among pixels in the area along the outer border of the image area defined as the non-image area in an ejection amount being equal to or less than the maximum ejection amount, and to decrease the ejection amount of the second liquid as the distance from the boundary increases.

13. A method forming an image with the recording apparatus according to claim 1.

14. A method forming an image with the recording apparatus according to claim 7.

15. A method forming an image with the recording apparatus according to claim 9.

16. A method forming an image with the recording apparatus according to claim 12.
